(19) United States
(12) Patent Application Publication
(10) Pub. No.: US 2025/0164782 A1
(43) Pub. Date: May 22, 2025

(54) System and Device

(71) Applicant: Envisics Ltd, Milton Keynes (GB)

(72) Inventors: Alexander Cole, Milton Keynes (GB); Jamieson Christmas, Milton Keynes (GB)

(21) Appl. No.: 18/841,317

(22) PCT Filed: Feb. 27, 2023
(86) PCT No.: PCT/EP2023/054810

§ 371 Date: Aug. 23, 2024

(30) Foreign Application Priority Data
Mar. 4, 2022 (GB) 2203030.8

(51) Int. Cl. G02B 27/01

(52) U.S. Cl. CPC G02B 27/0101; G02B 2027/0123

(57) ABSTRACT

A system comprising a first replicator, a second replicator and an optical element is described. The first replicator is arranged to receive a diffracted light field and replicate the diffracted light field in a first direction. The second replicator is arranged to receive output light from the first replicator and replicate the diffracted light field in a second direction, the second direction substantially perpendicular to the first direction. The optical element comprises a turning layer. The optical element is arranged to optically-couple output light from the first replicator to an input of the second replicator. The turning layer is arranged to turn a ray direction of output light from the first replicator.

### FIELD

The present disclosure relates to pupil expansion or replication, in particular, for a diffracted light field comprising diverging ray bundles and turning of the ray bundles. More specifically, the present disclosure relates a system comprising a pupil replicator and a turning layer. Some embodiments relate to two-dimensional pupil expansion, using first and second waveguide pupil expanders. Some embodiments relate to picture generating unit and a head-up display, for example an automotive head-up display (HUD).

### BACKGROUND AND INTRODUCTION

Light scattered from an object contains both amplitude and phase information. This amplitude and phase information can be captured on, for example, a photosensitive plate by well-known interference techniques to form a holographic recording, or “hologram”, comprising interference fringes. The hologram may be reconstructed by illumination with suitable light to form a two-dimensional or three-dimensional holographic reconstruction, or replay image, representative of the original object.

Computer-generated holography may numerically simulate the interference process. A computer-generated hologram may be calculated by a technique based on a mathematical transformation such as a Fresnel or Fourier transform. These types of holograms may be referred to as Fresnel/Fourier transform holograms or simply Fresnel/Fourier holograms. A Fourier hologram may be considered a Fourier domain/plane representation of the object or a frequency domain/plane representation of the object. A computer-generated hologram may also be calculated by coherent ray tracing or a point cloud technique, for example.

A computer-generated hologram may be encoded on a spatial light modulator arranged to modulate the amplitude and/or phase of incident light. Light modulation may be achieved using electrically-addressable liquid crystals, optically-addressable liquid crystals or micro-mirrors, for example.

A spatial light modulator typically comprises a plurality of individually-addressable pixels which may also be referred to as cells or elements. The light modulation scheme may be binary, multilevel or continuous. Alternatively, the device may be continuous (i.e. is not comprised of pixels) and light modulation may therefore be continuous across the device. The spatial light modulator may be reflective meaning that modulated light is output in reflection. The spatial light modulator may equally be transmissive meaning that modulated light is output in transmission.

A holographic projector may be provided using the system described herein. Such projectors have found application in head-up displays, “HUD”.

### SUMMARY

Aspects of the present disclosure are defined in the appended independent claims.

Broadly, the present disclosure relates to image projection. It relates to a method of image projection and an image projector which comprises a display device. The present disclosure also relates to a projection system comprising the image projector and a viewing system, in which the image projector projects or relays light from a display device to the viewing system. The present disclosure is equally applicable to a monocular and binocular viewing system. The viewing system may comprise a viewer's eye or eyes. The viewing system comprises an optical element having optical power (e.g., lens/es of the human eye) and a viewing plane (e.g., retina of the human eye/s). The projector may be referred to as a ‘light engine’. The display device and the image formed (or perceived) using the display device are spatially separated from one another. The image is formed, or perceived by a viewer, on a display plane. In some embodiments, the image is a virtual image and the display plane may be referred to as a virtual image plane. In other embodiments, the image is a real image formed by holographic reconstruction and the image is projected or relayed to the viewing plane. The image is formed by illuminating a diffractive pattern (e.g., hologram) displayed on the display device.

The display device comprises pixels. The pixels of the display may display a diffractive pattern or structure that diffracts light. The diffracted light may form an image at a plane spatially separated from the display device. In accordance with well-understood optics, the magnitude of the maximum diffraction angle is determined by the size of the pixels and other factors such as the wavelength of the light.

In embodiments, the display device is a spatial light modulator such as liquid crystal on silicon (“LCOS”) spatial light modulator (SLM). Light propagates over a range of diffraction angles (for example, from zero to the maximum diffractive angle) from the LCOS, towards a viewing entity/system such as a camera or an eye. In some embodiments, magnification techniques may be used to increase the range of available diffraction angles beyond the conventional maximum diffraction angle of an LCOS.

In some examples, an image (formed from the displayed hologram) is propagated to the eyes. For example, spatially modulated light of an intermediate holographic reconstruction/image formed either in free space or on a screen or other light receiving surface between the display device and the viewer, may be propagated to the viewer.

In some other examples, the (light of a) hologram itself is propagated to the eyes. For example, spatially modulated light of the hologram (that has not yet been fully transformed to a holographic reconstruction, i.e. image)-that may be informally said to be “encoded” with/by the hologram-is propagated directly to the viewer's eyes. A real or virtual image may be perceived by the viewer. In these embodiments, there is no intermediate holographic reconstruction/image formed between the display device and the viewer. It is sometimes said that, in these embodiments, the lens of the eye performs a hologram-to-image conversion or transform. The projection system, or light engine, may be configured so that the viewer effectively looks directly at the display device.

Reference is made herein to a “light field” which is a “complex light field”. The term “light field” merely indicates a pattern of light having a finite size in at least two orthogonal spatial directions, e.g. x and y. The word “complex” is used herein merely to indicate that the light at each point in the light field may be defined by an amplitude value and a phase value, and may therefore be represented by a complex number or a pair of values. For the purpose of hologram calculation, the complex light field may be a two-dimensional array of complex numbers, wherein the complex numbers define the light intensity and phase at a plurality of discrete locations within the light field.

In accordance with the principles of well-understood optics, the range of angles of light propagating from a display device that can be viewed, by an eye or other viewing entity/system, varies with the distance between the display device and the viewing entity. At a 1 meter viewing distance, for example, only a small range of angles from an LCOS can propagate through an eye's pupil to form an image at the retina for a given eye position. The range of angles of light rays that are propagated from the display device, which can successfully propagate through an eye's pupil to form an image at the retina for a given eye position, determines the portion of the image that is ‘visible’ to the viewer. In other words, not all parts of the image are visible from any one point on the viewing plane (e.g., any one eye position within a viewing window such as eye-motion box.)

In some embodiments, the image perceived by a viewer is a virtual image that appears upstream of the display device-that is, the viewer perceives the image as being further away from them than the display device. Conceptually, it may therefore be considered that the viewer is looking at a virtual image through an ‘display device-sized window’ or ‘eye box’, which may be very small, for example 1 cm in diameter, at a relatively large distance, e.g., 1 meter. And the user will be viewing the display device-sized window via the pupil(s) of their eye(s), which can also be very small. Accordingly, the field of view becomes small and the specific angular range that can be seen depends heavily on the eye position, at any given time.

A pupil expander (also known as a replicator) addresses the problem of how to increase the range of angles of light rays that are propagated from the display device that can successfully propagate through an eye's pupil to form an image. The display device is generally (in relative terms) small and the projection distance is (in relative terms) large. In some embodiments, the projection distance is at least one—such as, at least two-orders of magnitude greater than the diameter, or width, of the entrance pupil and/or aperture of the display device (i.e., size of the array of pixels). Embodiments of the present disclosure relate to a configuration in which a hologram of an image is propagated to the human eye rather than the image itself. In other words, the light received by the viewer is modulated according to a hologram of the image. However, other embodiments of the present disclosure may relate to configurations in which the image is propagated to the human eye rather than the hologram—for example, by so called indirect view, in which light of a holographic reconstruction or “replay image” formed on a screen (or even in free space) is propagated to the human eye.

Use of a pupil expander increases the viewing area (i.e., user's eye-box) in at least one dimension, thus enabling some movement of the eye/s to occur, whilst still enabling the user to see the image. As the skilled person will appreciate, in an imaging system, the viewing area (user's eye box) is the area in which a viewer's eyes can perceive the image. The present disclosure relates to non-infinite virtual image distances-that is, near-field virtual images.

Conventionally, a two-dimensional pupil expander comprises one or more one-dimensional optical waveguides each formed using a pair of opposing reflective surfaces, in which the output light from a surface forms a viewing window—e.g., eye-box or eye motion box for viewing by the viewer. Light received from the display device (e.g., spatially modulated light from a LCOS) is replicated by the or each waveguide so as to increase the field of view (or viewing area) in at least one dimension. In particular, the waveguide enlarges the viewing window due to the generation of extra rays or “replicas” by division of amplitude of the incident wavefront.

The display device may have an active or display area having a first dimension that may be less than 10 cm such as less than 5 cm or less than 2 cm. The propagation distance between the display device and viewing system may be greater than 1 m such as greater than 1.5 m or greater than 2 m. The optical propagation distance within the waveguide may be up to 2 m such as up to 1.5 m or up to 1 m. The method may be capable of receiving an image and determining a corresponding hologram of sufficient quality in less than 20 ms such as less than 15 ms or less than 10 ms.

In some embodiments—described only by way of example of a diffracted or holographic light field in accordance with this disclosure—a hologram is configured to route light into a plurality of channels, each channel corresponding to a different part (i.e. sub-area) of an image. The hologram may be represented, such as displayed, on a display device such as a spatial light modulator. When displayed on an appropriate display device, the hologram may spatially modulate light transformable by a viewing system into the image. The channels formed by the diffractive structure are referred to herein as “hologram channels” merely to reflect that they are channels of light encoded by the hologram with image information. It may be said that the light of each channel is in the hologram domain rather than the image or spatial domain. In some embodiments, the hologram is a Fourier or Fourier transform hologram and the hologram domain is therefore the Fourier or frequency domain. The hologram may equally be a Fresnel or Fresnel transform hologram. The hologram is described herein as routing light into a plurality of hologram channels merely to reflect that the image that can be reconstructed from the hologram has a finite size and can be arbitrarily divided into a plurality of image sub-areas, wherein each hologram channel would correspond to each image sub-area. Importantly, the hologram of this example is characterised by how it distributes the image content when illuminated. Specifically, the hologram divides the image content by angle. That is, each point on the image is associated with a unique light ray angle in the spatially modulated light formed by the hologram when illuminated—at least, a unique pair of angles because the hologram is two-dimensional. For the avoidance of doubt, this hologram behaviour is not conventional. The spatially modulated light formed by this special type of hologram, when illuminated, may be arbitrarily divided into a plurality of hologram channels, wherein each hologram channel is defined by a range of light ray angles (in two-dimensions). It will be understood from the foregoing that any hologram channel (i.e. sub-range of light ray angles) that may be considered in the spatially modulated light will be associated with a respective part or sub-area of the image. That is, all the information needed to reconstruct that part or sub-area of the image is contained within a sub-range of angles of the spatially modulated light formed from the hologram of the image. When the spatially modulated light is observed as a whole, there is not necessarily any evidence of a plurality of discrete light channels. However, in some arrangements, a plurality of spatially separated hologram channels is formed by intentionally leaving areas of the target image, from which the hologram is calculated, blank or empty (i.e., no image content is present).

Nevertheless, the hologram may still be identified. For example, if only a continuous part or sub-area of the spatially modulated light formed by the hologram is reconstructed, only a sub-area of the image should be visible. If a different, continuous part or sub-area of the spatially modulated light is reconstructed, a different sub-area of the image should be visible. A further identifying feature of this type of hologram is that the shape of the cross-sectional area of any hologram channel substantially corresponds to (i.e. is substantially the same as) the shape of the entrance pupil although the size may be different—at least, at the correct plane for which the hologram was calculated. Each light/hologram channel propagates from the hologram at a different angle or range of angles. Whilst these are example ways of characterising or identifying this type of hologram, other ways may be used. In summary, the hologram disclosed herein is characterised and identifiable by how the image content is distributed within light encoded by the hologram. Again, for the avoidance of any doubt, reference herein to a hologram configured to direct light or angularly-divide an image into a plurality of hologram channels is made by way of example only and the present disclosure is equally applicable to pupil expansion of any type of holographic light field or even any type of diffractive or diffracted light field.

Broadly, a system is disclosed herein that provides pupil expansion for an input light field, wherein the input light field is a diffracted or holographic light field comprising diverging ray bundles. As discussed above, pupil expansion (which may also be referred to as “image replication” or “replication” or “pupil replication”) enables the size of the area at/from which a viewer can see an image (or, can receive light of a hologram, which the viewer's eye forms an image) to be increased, by creating one or more replicas of an input light ray (or ray bundle). The pupil expansion can be provided in one or more dimensions. For example, two-dimensional pupil expansion can be provided, with each dimension being substantially orthogonal to the respective other.

The system can be provided in a compact and streamlined physical form. This enables the system to be suitable for a broad range of real-world applications, including those for which space is limited and real-estate value is high. For example, it may be implemented in a head-up display (HUD) such as a vehicle or automotive HUD.

In accordance with the present disclosure, pupil expansion is provided for diffracted or diffractive light, which may comprise diverging ray bundles. The diffractive or diffracted light may be output by a display device such as a pixelated display device such as a spatial light modulator (SLM) arranged to display a diffractive structure such as a hologram. The diffracted light field may be defined by a “light cone”. Thus, the size of the diffracted light field (as defined on a two-dimensional plane) increases with propagation distance from the corresponding diffractive structure (i.e. display device).

The spatial light modulator may be arranged to display a hologram. The diffracted or diverging light may comprise light encoded with/by the hologram, as opposed to being light of an image or of a holographic reconstruction. In such embodiments, it can therefore be said that the pupil expander replicates the hologram or forms at least one replica of the hologram, to convey that the light delivered to the viewer is spatially modulated in accordance with a hologram of an image, not the image itself. That is, a diffracted light field is propagated to the viewer.

In some embodiments, two one-dimensional waveguide pupil expanders are provided, each one-dimensional waveguide pupil expander being arranged to effectively increase the size of the exit pupil of the system by forming a plurality of replicas or copies of the exit pupil (or light of the exit pupil) of the spatial light modulator. The exit pupil may be understood to be the physical area from which light is output by the system. It may also be said that each waveguide pupil expander is arranged to expand the size of the exit pupil of the system. It may also be said that each waveguide pupil expander is arranged to expand/increase the size of the eye box within which a viewer's eye can be located, in order to see/receive light that is output by the system.

In some embodiments, an optical element comprising a turning layer is provided. The optical element is arranged to couple light emitted from the output region of a first pupil expander (or replicator) to a second pupil expander (or replicator). The turning layer turns the output light such that the directions of expansion in the first and second expanders (or replicators) are aligned. The use of a turning layer may allow for a less bulky system in comparison to conventional optics to turn the light.

In some embodiments, the turning comprises a diffractive optical element. The diffractive optical element may be arranged to diffract a wavefront/light that it receives. The diffractive optical element may comprise features having a feature size less than the wavelength of the wavefront/light. Each diffracted wavefront may comprise a zeroth order of diffraction (also referred to as a zero order) and one or more non-zero or “higher” orders of diffraction. The diffractive optical element may be arranged so that the wavefront is principally diffracted into one non-zero diffraction order of a plurality of non-zero diffraction orders. In some embodiments, each (wavefront) replica of a plurality of (wavefront) replicas formed by a first replicator is diffracted by the diffractive optical element. In these embodiments, it may be said that there are a plurality of diffraction sites, wherein each diffraction site corresponds to a different replica. Likewise, it may be said that there are a plurality of diffraction events—for example, spatially-separated along a propagation direction of the first replicator. Each replica is principally diffracted into the same diffraction order as the other replicas (albeit originating from a different location on the diffractive optical element). For example, each replica may be diffracted into the +1 diffraction order of its respective diffraction site. In other words, the diffractive optical element may be described as being arranged to principally redirect each replica (of a plurality of replicas formed by a first replicator) into a corresponding non-zero diffractive order defined by a diffraction angle. For example, each replica may be principally redirected into a respective first diffractive order such as the +1 or −1 diffractive order.

The diffractive optical element may be arranged such that the non-zero diffraction order may be directed at a desired angle. Furthermore, the inventors have found that such a diffractive optical element can advantageously redirect or turn the light in two planes. The inventors have found that the diffractive optical element described above advantageously allows for the wavefront replicas emitted by the waveguide to be effectively redirected or turned with fine control of the angle of the “diffracted” or “redirected” (non-zero order) component of the wavefronts. Furthermore, the inventors have found that such a diffractive optical element can advantageously be manufactured in a way which does not result in dark bands in the holographic projection, or scattering. The inventors have also surprisingly found that the use of a diffractive optical element allows for wavefront replicas emitted by the waveguide to be redirected or turned without substantial degradation of the hologram or reconstruction.

The diffractive optical element may comprise one or more patterns. The one or more patterns may be diffractive patterns. Each pattern may comprise one or more diffraction gratings. The diffractive optical element may be a holographic optical element. The holographic optical element may comprise one or more holograms (such as a computer-generated hologram) recorded in the optical element. The or each hologram may be calculated/arranged to diffract the wavefront as described above so that the intensity of the principal diffraction order is maximized and directed/redirected at a desired angle. The holographic optical element may be a volume diffraction element/volume holographic optical element. The holographic optical element may comprise a volume hologram. The holographic optical element may comprise a volume Bragg grating.

In some embodiments, the diffractive optical element may comprise a plurality of layers. The plurality of layers may form a stack. At least some, optionally each, of the layers may comprise a pattern such as a diffractive pattern or hologram. The diffractive pattern of at least some, optionally each, of the layers may comprise a different diffractive pattern or hologram. The combination of each of the layers in the stack combined may form a volume diffraction pattern/volume hologram/volume Bragg grating, as described above. Each of the layers may comprise a photopolymer film. Each of the layers comprising a photopolymer film may comprise a varying refractive index which may have a periodic modulation function.

In some embodiments, the diffractive optical element comprises a photosensitive material such as silver halide or photopolymer such as dichromated gelatin. In some embodiments, the diffractive optical element may be in the form of a film such as a thin-film, optionally having a thickness of between 0.1 nanometre and 10 micrometres, optionally having a thickness of between 10 nanometres and 1 micrometre. The film may be or comprise a photopolymer film. A refractive index of the photopolymer film may vary across the height and/or width of photopolymer film. The varying refractive index may form one or more patterns, such as diffractive patterns/gratings. The refractive index of the film may have a periodic modulation function. The periodic modulation function may have a respective periodicity and axis/angle. The varying refractive index may diffract the wavefronts emitted by the waveguide and received by the diffractive optical element.

In some embodiments, the system further comprises an array of louvres. The array of louvres may be arranged to receive the light after the diffractive optical element-that is, output by the diffractive optical element. For example, the array of louvres may be arranged to receive a zeroth diffractive order and at least one or some, preferably all, of the non-zero diffractive orders, including the principal non-zero diffraction order. The array of louvres may be arranged to be substantially transmissive at the non-zero diffraction angle of the diffractive optical element. This may mean that the common (principal) non-zero diffraction order is transmittable through the array of louvres. In other words, the array of louvres is transmissive to the non-zero diffraction order such as transmissive at the angle of the non-zero diffraction order. The array of louvres may be non-transmissive to other orders or angles of diffraction. The individual louvres of the array of louvres may be formed of or comprise a substantially opaque material. The individual louvres of the array of louvres may be configured to substantially absorb light but gaps or spaces between the louvres can transmit light, of course. The individual louvres may be negligibly thin such that proportion of light angled parallel to the louvres that is absorbed by the thickness/an end face of the louvres is substantially negligible. For example, the distance between adjacent louvres may be at least five times, optionally at least 10 or 20 times greater than the thickness of an individual louvre. The array of louvres being arranged to be substantially transmissive at the non-zero diffraction angle of the diffractive optical element may mean that the individual louvres of the array of louvres are arranged (for example, sized and/or angled) to substantially allow light at the respective non-zero diffraction angle to be transmitted by the array of louvres.

The array of louvres may be substantially non-transmissive at a zeroth diffraction angle of the diffractive optical element. For example, the array of louvres may be arranged to directly receive and substantially absorb light of the zeroth diffraction order emitted at the zeroth order of the diffractive optical element. In other words, the zeroth order of each replica may be incident upon a louvre. Thus, the light of the zeroth diffraction order may be prevented from being transmitted beyond the array of louvres and, in particular, may be substantially prevented from being received by a viewing system. The zeroth diffraction order may have a different diffraction angle to the non-zero diffraction light (in particular, the common—principal—non-zero diffraction order).

The zeroth order corresponds to a proportion of light that is transmitted by the diffractive optical element rather than diffracted. Thus, the diffractive optical element cannot be used to control the diffraction angle of the zero order (e.g. to prevent the zero order from propagating further through a system). So, it is particularly advantageous for the array of louvres to be arranged to block the zeroth order. However, the array of louvres may additionally or alternatively be substantially non-transmissive to one or more other diffractive angles of other diffraction orders. The one or more other diffractive angles may comprise one or more non-zero diffraction orders that are different to the common (principal) non-zero diffraction orders. For example, if the common (principal) non-zero diffraction order is the first non-zero diffraction order, the one or more other diffractive angles may comprise one or more non-zero diffraction orders being greater than the first diffractive order. The array of louvres may be substantially non-transmissive to all diffractive order at respective diffractive angles other than the respective common (principal) non-zero diffraction order. The louvres may be arranged to substantially block all diffraction orders other than the principal order (the louvres may be substantially transmissive to the principal order).

In some embodiments the turning layer may comprise a prismatic turning layer, such that the layer comprises a plurality of prism elements arranged in a layer. The use of a prismatic layer may allow the turning layer to be conveniently applied to the optical element.

A prismatic layer may mean a layer that comprises multiple prisms. The prismatic layer may comprise a sawtooth structure, a pyramidal structure, or a flat-topped structure. The type of structure may depend on the requirements and arrangement of the optical system.

Through simulation and experimentation, the inventors have found that, in some arrangements, the use of a prismatic layer as a turning layer may introduce artefacts in the turned light. These artefacts could include dark bands, stray light rays and/or breaks in the coherence of the turned light. In embodiments where the system is arranged to expand an exit pupil and to propagate light to an eye-box from which a virtual image is viewable, these artefacts could adversely affect the quality of the virtual image viewed at the exit pupil. Having recognised that a prismatic layer may introduce artefacts in the turned light, the inventors have devised a number of optional features which may act to minimise said artefacts.

In some embodiments, a sawtooth structure of prismatic layer may be particularly preferred. The use of a prismatic layer may minimise the introduction of dark bands in the turned light created at the boundary between prisms, relative to other prism shapes (e.g. pyramidal).

In some embodiments, the prismatic layer may comprise a first surface and a second surface. The first surface may be opposite the second surface. The first surface may form an input port of the prismatic layer. The second surface may form an output port of the prismatic layer. The first surface may have a serrated structure. The serrated structure of the first surface may be defined by individual prisms. For example, each prism may define a single serration of the serrated surface. Each of the serrations may be angled with respect to a general plane of prismatic layer. Each serration may have a sawtooth (including triangular), pyramidal or flat-topped profile. Each serration may comprise a first face and a second face. The first face may be connected to the second face. Both the first face and the second face may be angled with respect to the general plane of the prismatic layer. Both the first face and the second face may be angled with respect to one another. The angle between the first face and the plane of the prismatic layer may be less than the angle between the second face and the plane of the prismatic layer. A width of the first face may be larger than a width of the second face. The second surface may have a generally planar (e.g. non-serrated or flat) structure. The planar second surface may be parallel to the general plane of the prismatic layer.

The inventors have found that a turning layer comprising such a prismatic layer is preferably arranged such that the first (serrated) surface acts as the input port. In other words, it is preferable for the first (serrated) surface to receive the light to be turned and for the turned light to be emitted by the second (planar) surface. Through simulation and experimentation, the inventors have found that dark bands may be reduced in such an arrangement. In some embodiments, the first surface of the prismatic turning layer may be closer to the first pupil expander (replicator) than the second surface of the prismatic turning layer.

In some embodiments, each second face of the prismatic turning layer may comprise a light absorbing material. For example, the light absorbing material may be provided as a coating on each second face. The light absorbing material may substantially cover each second face of the prismatic turning layer. The light absorbing material may advantageously reduce or minimise stray light beams from being transmitted by the turning film. In particular, the light absorbing material may advantageously reduce or minimise or eliminate stray light beams from being created by the second face(s). A first portion of light incident on the first surface of the prismatic turning layer may be incident on the first face(s) of the first surface and a second portion of light incident on the first surface of the prismatic turning layer may be incident on the second face(s) of the first surface. The first portion of light may be turned about a first angle. This angle may depend on the angle of the first face(s) with respect to the plane of the turning layer. The second portion of light may be turned a different angle. This may create “stray” light rays that are angled with respect to the light rays that are turned by the first faces. Furthermore, the angle of the second portion of light with respect to the second face may be such that some of the second portion of light is reflected within the prism before being emitted (e.g. totally internally reflected one or more times within the prism). This may result in “stray” light being emitted at one or more angles (that are different to the angles of the turned first portion of light). By applying a light absorbing material to the second faces of the first surface of the turning layer, the second portion of light may be absorbed and so may not go on to create stray light rays.

In some embodiments, the pitch of the prismatic turning layer may be 1 millimetre or more, optionally 2 millimetres or more. As used herein, the pitch of the prismatic turning layer refers to the distance between vertices of neighbouring/adjacent prisms forming the prismatic turning layer. In some embodiments, the turning layer is arranged to turn substantially coherent light. For example, the coherent light may be light that has been emitted by a laser. In such embodiments, the first replicator may be arranged to replicate a substantially coherent diffractive light field. The light output by the first replicator may be substantially coherent light. It is desirable that the light remains substantially coherent after it has been received (and turned) by the turning layer. However, the inventors have found that there may be a break in the coherence of light propagated through adjacent/neighbouring prisms. For example, first light propagated (and turned) by a first prism of the prismatic turning layer may be coherent with itself and second light propagated (and turned) by a second prism (that is adjacent to/neighbouring the first prism) may be coherent with itself. But the first light may not be coherent with the second light (after propagating through the turning layer). In other words, the turned light may comprise portions or strips of coherent light but the light of adjacent strips may not be coherent. The inventors have found that this is undesirable. For example, when the light is spatially modulated light, modulated in accordance with a hologram of a picture, the inventors have found that pixels in a holographic reconstruction of the hologram may be enlarged as a result of the breaks in coherence. There may be a potential reduction in resolution of the holographic reconstruction. The inventors have found that increasing the pitch of the prismatic turning layer reduces this effect because the width of “strips” of coherent light are also increased. Through simulation and experimentation, the inventors have found that a prismatic turning layer of 1 millimetre or more, optionally 2 millimetres or more to be good at reducing the effect of resolution reduction/pixel size increase.

In some embodiments the turning layer may be manufactured separate from the optical element and bonded to the optical element. In some embodiments the turning layer may be formed directly on the optical element.

In some examples the turning layer may comprises two functionally different layers. A first layer may be used to turn the light in a first direction such that it is at the correct angle for the directions of expansion in the pupil replicators to align, and a second layer may be used to fold the light towards the second pupil replicator, and such acts as a fold mirror. The use of the second turning layer may allow for the system to be more compact.

In some embodiments, the first and second turning layer may be a single layer. Single may mean that there is substantially no other layer in-between the first and second turning layer. A single layer may be formed in a single process step, or may be formed in multiple process steps. The use of a single layer may simplify the fabrication process. The single layer may be integrally formed.

In some embodiments, the single layer comprises a single prismatic layer. The single prismatic layer may comprise multiple individual microstructures (e.g. prisms), as described previously. In some embodiments, the single prismatic layer may be substantially planar and extend substantially in a first direction and a second direction, the first direction being orthogonal to the second direction. For example, the single prismatic layer may be substantially rectangular or square (or, at least, may be arranged to receive light over a substantially rectangular or square area). In some embodiments, the first direction may be substantially horizontal and the second direction may be substantially vertical. The microstructures/prisms of the single prismatic layer may extend in a third direction that is not parallel to the first and second direction. In some embodiments, the microstructures/prisms of the single prismatic layer may extend in a non-vertical and non-horizontal direction. In this way, the single prismatic layer may advantageously be arranged to correct both the ray direction not being normal at an exit surface of the first replicator and so that the angle of incidence on the second replicator is such that the light ray/diffracted light field is replicated by the second replicator. Such an arrangement of the single prismatic layer may achieve a similar effect to providing a superposition of two orthogonal/perpendicular prismatic layers. However, the inventors have found that providing a single prismatic layer is advantageous this arrangement may result in larger regions of coherent light which, as above, is advantageous.

In some embodiments the first and second turning layer may be opposing. This may result in the layers being closer together, and therefore reducing divergence of light between layers.

A turning layer may be described as a layer that turns or rotates an optical axis of light such that the input optical axis onto the turning layer and the output optical axis from the turning layer are not parallel. In this context, the optical axis refers to the overall or group propagation direction of light. For a diffracted light field the input light rays may have a range of values, and therefore the turning layer may turn each of the rays a different amount. An amount of turning of the turning layer may be defined based on the magnitude of the overall turn in the optical axis of the light.

In some embodiments a turning layer may require input and output faces that are not parallel, such that light exiting and entering the turning layer is refracted by different amounts on input and output.

In some embodiments a turning layer may turn light only in a single plane. In some embodiments a turning layer may turn light in two orthogonal planes. In some embodiments the amount of turning in one plane may be different to the amount of turning in the second plane. In some embodiments the amount of turning in one plane may be the same as the amount of turning in the second plane.

In some embodiments the amount of turning may be between 5° to 25°. However, the amount of turning is not limited to these values. The amount of turning may depend upon the specific arrangement of the optical system.

In some embodiments, the second pupil expander (or replicator) receives light at an acute angle of incidence relative to the propagation along the second pupil expander (or replicator). This allows for the correct amount of replication or expansion to be caused in the pupil expander (or replicator).

In some embodiments, the optical element may be arranged on the first pupil expander (or replicator), the second pupil expander (or replicator) or a combination of the first replicator and the second pupil expander (or replicator). This may reduce the size of the device, and also reduce the size of any gaps between elements of the display system. This in turn may reduce the amount of divergence of light in the gaps, and therefore lead to a more efficient system.

In some embodiments, the turning layer the turning layer may be arranged on the output of the first expander (or replicator). This may reduce the size of the device, and also may reduce the requirement for alignment of elements of the device, reducing the complexity of fabrication.

In some embodiments, the turning layer may be arranged on the second expander (or replicator). This may reduce the size of the device, and also may reduce the requirement for alignment of elements of the device, reducing the complexity of fabrication.

In some embodiments, the second turning layer is arranged on the input of the second expander (or replicator). This reduces the gap between the elements, reducing the amount of divergence of the light and increasing efficiency of the system.

In some embodiments, the optical element is an aperture device, arranged to selectively block parts of the diffracted light beam to reduce cross-talk. In other words, the aperture device may comprise the turning layer. Applying the turning layer(s) to the aperture device also reduces gaps between components, which reduces the amount of divergence of the light and increases the efficiency of the system.

In some embodiments, a device is disclosed. The device may alternatively be known as a switching device or an aperture device. The device comprises a 1D array of cells, wherein each cell is independently switchable between a first state and a second state. The device also comprises at least one turning layer arranged to change the direction of the transmitted light. Each cell is configured to receive diffracted light from an output region of a first expander (or replicator). Each cell, if in the first state, is configured to output the diffracted light towards an input region of a second expander (or replicator). Each cell, if in the second state, is configured to interact with the diffracted light such that the diffracted light remains uncoupled into the second expander (or replicator).

In some embodiments, the device is a liquid crystal device (LCD). Each cell of the LCD may be switched between a substantially transparent state and a substantially opaque state. In the transparent light may be allowed to couple into the second replicator. However, it is to be understood that alternative arrangements are possible, where the light is coupled into the second replicator when the LCD cell is in a transparent state.

In some embodiments, the device comprises a first transparent substrate configured to receive diffracted light and a second transparent substrate configured to output light, and wherein the 1D array of cells is located in an optical path between the first transparent substrate and the second transparent substrate and the at least one turning layer is arranged on at least one of the first transparent substrate and the second transparent substrate. The first and second transparent substrates may act as containing layers for an LCD.

In some embodiments, the device is a microelectromechanical systems (MEMS) device, wherein each cell comprises a switchable mirror, the switchable mirror switchable between the first state and the second state.

In some embodiments, each switchable mirror is configured to direct the diffracted light towards a sensor for monitoring the diffracted light. Directing light to a sensor allows for the integrity of the image displayed to the user to be monitored, without requiring a sensor in the eye-line of the user. This may allow malfunctions or other issues to be detected, which is particularly useful when the system is part of a safety critical function, such as part of a HUD in a vehicle.

In some embodiments, the turning layer comprises a first array of prisms and a second array of prisms, wherein each prism of the first array comprises at least one optical surface that is orthogonal to at least one optical surface of each prism of the second array of prisms.

In some embodiments, switching between the first state and the second state is based on an output of an eye tracking sensor. This may allow for the switching device to be optimised such that the switching is dependent on where the user is looking.

There is also disclosed herein a display system comprising a first replicator, second replicator and optical element. The first replicator arranged to (directly or indirectly) receive a diffracted (e.g. holographic) light field (from a display device e.g. spatial light modulator) and replicate the diffracted light field in a first direction. The second replicator is arranged to receive the output from the first replicator and further replicate the diffracted light field in a second direction (perpendicular to the first direction). The optical element (e.g. optical film or turning film or prismatic film) is arranged to optically-couple the output of the first replicator to the input of the second replication. The optical element is arranged to change the angle of incidence of the light coupled from the first replicator to the second replicator (such that the first replicator and second replicator are substantially co-planar and/or a plane of the first replicator is substantially parallel to a plane of the second replicator).

There is further disclosed herein a liquid crystal device comprising a 1D array of cells and a transparent substrate. Each cell of the 1D array of cells is independently switchable between a substantially transparent state and a substantially opaque state (to form a shutter array). The transparent substrate (e.g. cover glass or transparent electrode) is arranged to receive and transmit light, wherein the transparent surface comprises a structured surface (e.g. a prismatic structure) arranged to change the direction of the received or transmitted light.

In the present disclosure, the term “replica” is merely used to reflect that spatially modulated light is divided such that a complex light field is directed along a plurality of different optical paths. The word “replica” is used to refer to each occurrence or instance of the complex light field after a replication event—such as a partial reflection-transmission by a pupil expander. Each replica travels along a different optical path. Some embodiments of the present disclosure relate to propagation of light that is encoded with a hologram, not an image—i.e., light that is spatially modulated with a hologram of an image, not the image itself. The person skilled in the art of holography will appreciate that the complex light field associated with propagation of light encoded with a hologram will change with propagation distance. Use herein of the term “replica” is independent of propagation distance and so the two branches or paths of light associated with a replication event are still referred to as “replicas” of each other even if the branches are a different length, such that the complex light field has evolved differently along each path. That is, two complex light fields are still considered “replicas” in accordance with this disclosure even if they are associated with different propagation distances-providing they have arisen from the same replication event or series of replication events.

A “diffracted light field” or “diffractive light field” in accordance with this disclosure is a light field formed by diffraction. A diffracted light field may be formed by illuminating a corresponding diffractive pattern. In accordance with this disclosure, an example of a diffractive pattern is a hologram and an example of a diffracted light field is a holographic light field or a light field forming a holographic reconstruction of an image. The holographic light field forms a (holographic) reconstruction of an image on a replay plane. The holographic light field that propagates from the hologram to the replay plane may be said to comprise light encoded with the hologram or light in the hologram domain. A diffracted light field is characterized by a diffraction angle determined by the smallest feature size of the diffractive structure and the wavelength of the light (of the diffracted light field). In accordance with this disclosure, it may also be said that a “diffracted light field” is a light field that forms a reconstruction on a plane spatially separated from the corresponding diffractive structure. An optical system is disclosed herein for propagating a diffracted light field from a diffractive structure to a viewer. The diffracted light field may form an image.

The term “hologram” is used to refer to the recording which contains amplitude information or phase information, or some combination thereof, regarding the object. The term “holographic reconstruction” is used to refer to the optical reconstruction of the object which is formed by illuminating the hologram. The system disclosed herein is described as a “holographic projector” because the holographic reconstruction is a real image and spatially-separated from the hologram. The term “replay field” is used to refer to the 2D area within which the holographic reconstruction is formed and fully focused. If the hologram is displayed on a spatial light modulator comprising pixels, the replay field will be repeated in the form of a plurality diffracted orders wherein each diffracted order is a replica of the zeroth-order replay field. The zeroth-order replay field generally corresponds to the preferred or primary replay field because it is the brightest replay field. Unless explicitly stated otherwise, the term “replay field” should be taken as referring to the zeroth-order replay field. The term “replay plane” is used to refer to the plane in space containing all the replay fields. The terms “image”, “replay image” and “image region” refer to areas of the replay field illuminated by light of the holographic reconstruction. In some embodiments, the “image” may comprise discrete spots which may be referred to as “image spots” or, for convenience only, “image pixels”.

The terms “encoding”, “writing” or “addressing” are used to describe the process of providing the plurality of pixels of the SLM with a respective plurality of control values which respectively determine the modulation level of each pixel. It may be said that the pixels of the SLM are configured to “display” a light modulation distribution in response to receiving the plurality of control values. Thus, the SLM may be said to “display” a hologram and the hologram may be considered an array of light modulation values or levels.

It has been found that a holographic reconstruction of acceptable quality can be formed from a “hologram” containing only phase information related to the Fourier transform of the original object. Such a holographic recording may be referred to as a phase-only hologram. Embodiments relate to a phase-only hologram but the present disclosure is equally applicable to amplitude-only holography.

The present disclosure is also equally applicable to forming a holographic reconstruction using amplitude and phase information related to the Fourier transform of the original object. In some embodiments, this is achieved by complex modulation using a so-called fully complex hologram which contains both amplitude and phase information related to the original object. Such a hologram may be referred to as a fully-complex hologram because the value (grey level) assigned to each pixel of the hologram has an amplitude and phase component. The value (grey level) assigned to each pixel may be represented as a complex number having both amplitude and phase components. In some embodiments, a fully-complex computer-generated hologram is calculated.

Reference may be made to the phase value, phase component, phase information or, simply, phase of pixels of the computer-generated hologram or the spatial light modulator as shorthand for “phase-delay”. That is, any phase value described is, in fact, a number (e.g. in the range 0 to 2π) which represents the amount of phase retardation provided by that pixel. For example, a pixel of the spatial light modulator described as having a phase value of π/2 will retard the phase of received light by π/2 radians. In some embodiments, each pixel of the spatial light modulator is operable in one of a plurality of possible modulation values (e.g. phase delay values). The term “grey level” may be used to refer to the plurality of available modulation levels. For example, the term “grey level” may be used for convenience to refer to the plurality of available phase levels in a phase-only modulator even though different phase levels do not provide different shades of grey. The term “grey level” may also be used for convenience to refer to the plurality of available complex modulation levels in a complex modulator.

The hologram therefore comprises an array of grey levels-that is, an array of light modulation values such as an array of phase-delay values or complex modulation values. The hologram is also considered a diffractive pattern because it is a pattern that causes diffraction when displayed on a spatial light modulator and illuminated with light having a wavelength comparable to, generally less than, the pixel pitch of the spatial light modulator. Reference is made herein to combining the hologram with other diffractive patterns such as diffractive patterns functioning as a lens or grating. For example, a diffractive pattern functioning as a grating may be combined with a hologram to translate the replay field on the replay plane or a diffractive pattern functioning as a lens may be combined with a hologram to focus the holographic reconstruction on a replay plane in the near field.

Although different embodiments and groups of embodiments may be disclosed separately in the detailed description which follows, any feature of any embodiment or group of embodiments may be combined with any other feature or combination of features of any embodiment or group of embodiments. That is, all possible combinations and permutations of features disclosed in the present disclosure are envisaged.

In the present disclosure, the term “substantially” when applied to a structural units of an apparatus may be interpreted as the technical feature of the structural units being produced within the technical tolerance of the method used to manufacture it.

### BRIEF DESCRIPTION OF THE DRAWINGS

Specific embodiments are described by way of example only with reference to the following figures:

FIG. 1 is a schematic showing a reflective SLM producing a holographic reconstruction on a screen;

FIG. 2 shows an image for projection comprising eight image areas/components, V1 to V8;

FIG. 3 shows a hologram displayed on an LCOS that directs light into a plurality of discrete areas.

FIG. 4 shows a system, including a display device that displays a hologram that has been calculated as illustrated in FIGS. 2 and 3;

FIG. 5 shows a perspective view of a system comprising two replicators arranged for expanding a light beam in two dimensions;

FIG. 6A shows a system comprising an optical wedge;

FIG. 6B shows the system in side view;

FIG. 7 shows a plan view of a system comprising a turning layer;

FIG. 8A shows a side view of a system comprising a switching element;

FIG. 8B shows a rear view of a system comprising a switching element, the switching element comprising a first and second turning layer;

FIG. 9 shows a side view of a system comprising a switching device comprising a turning layer formed as a single layer;

FIG. 10 shows and optical element comprising a first and second turning layer;

FIG. 11 shows a liquid crystal device comprising a first and second turning layer;

FIG. 12 shows a liquid crystal device comprising a first and second turning layer;

FIG. 13A shows a schematic side view of a system comprising a first replicator and a turning layer;

FIG. 13B shows a schematic side view of the first replicator and the turning layer, in which the turning layer is rotated relative to FIG. 13B;

FIG. 14 shows a schematic perspective view of a turning layer comprising a single prismatic layer;

FIG. 15A shows a portion of light output by the turning layer shown in FIG. 10;

FIG. 15B represents a portion of light output by the turning layer shown in FIG. 14; and

FIG. 16 shows a side view of another example of a system comprising a switching device and a turning layer comprising a diffractive optical element.

The same reference numbers will be used throughout the drawings to refer to the same or like parts.

### DETAILED DESCRIPTION OF EMBODIMENTS

The present invention is not restricted to the embodiments described in the following but extends to the full scope of the appended claims. That is, the present invention may be embodied in different forms and should not be construed as limited to the described embodiments, which are set out for the purpose of illustration.

Terms of a singular form may include plural forms unless specified otherwise.

A structure described as being formed at an upper portion/lower portion of another structure or on/under the other structure should be construed as including a case where the structures contact each other and, moreover, a case where a third structure is disposed there between.

In describing a time relationship—for example, when the temporal order of events is described as “after”, “subsequent”, “next”, “before” or suchlike—the present disclosure should be taken to include continuous and non-continuous events unless otherwise specified. For example, the description should be taken to include a case which is not continuous unless wording such as “just”, “immediate” or “direct” is used.

Although the terms “first”, “second”, etc. may be used herein to describe various elements, these elements are not to be limited by these terms. These terms are only used to distinguish one element from another. For example, a first element could be termed a second element, and, similarly, a second element could be termed a first element, without departing from the scope of the appended claims.

Features of different embodiments may be partially or overall coupled to or combined with each other, and may be variously inter-operated with each other. Some embodiments may be carried out independently from each other, or may be carried out together in co-dependent relationship.

### Optical Configuration

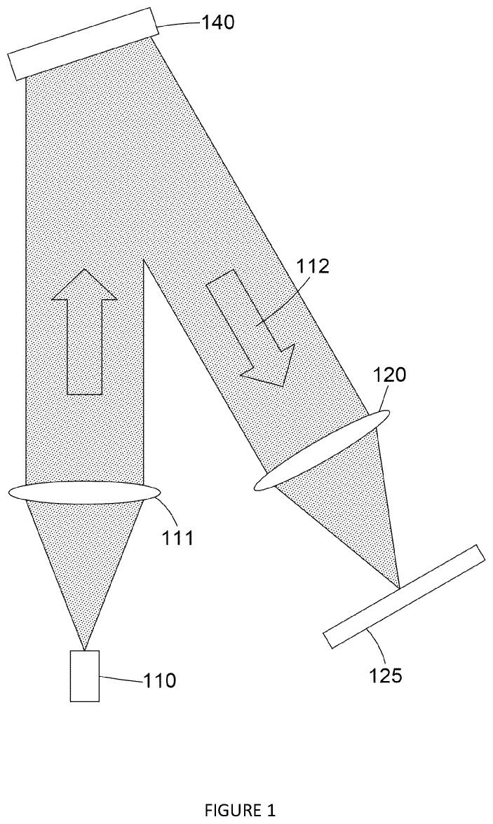

FIG. 1 shows an embodiment in which a computer-generated hologram is encoded on a single spatial light modulator. The computer-generated hologram is a Fourier transform of the object for reconstruction. It may therefore be said that the hologram is a Fourier domain or frequency domain or spectral domain representation of the object. In this embodiment, the spatial light modulator is a reflective liquid crystal on silicon, “LCOS”, device. The hologram is encoded on the spatial light modulator and a holographic reconstruction is formed at a replay field, for example, a light receiving surface such as a screen or diffuser.

A light source 110, for example a laser or laser diode, is disposed to illuminate the SLM 140 via a collimating lens 111. The collimating lens 111 causes a generally planar wavefront of light to be incident on the SLM 140. In FIG. 1, the direction of the wavefront is off-normal (e.g. two or three degrees away from being truly orthogonal to the plane of the transparent layer). However, in other embodiments, the generally planar wavefront is provided at normal incidence and a beam splitter arrangement is used to separate the input and output optical paths. In the embodiment shown in FIG. 1, the arrangement is such that light from the light source 110 is reflected off a mirrored rear surface of the SLM and interacts with a light-modulating layer to form an exit wavefront 112. The exit wavefront 112 is applied to optics including a Fourier transform lens 120, having its focus at a screen 125. More specifically, the Fourier transform lens 120 receives a beam of modulated light from the SLM 140 and performs a frequency-space transformation to produce a holographic reconstruction at the screen 125.

Notably, in this type of holography, each pixel of the hologram contributes to the whole reconstruction. There is not a one-to-one correlation between specific points (or image pixels) on the replay field and specific light-modulating elements (or hologram pixels). In other words, modulated light exiting the light-modulating layer is distributed across the replay field.

In these embodiments, the position of the holographic reconstruction in space is determined by the dioptric (focusing) power of the Fourier transform lens 120. In the embodiment shown in FIG. 1, the Fourier transform lens 120 is a physical lens. That is, the Fourier transform lens 120 is an optical Fourier transform lens and the Fourier transform is performed optically. Any lens can act as a Fourier transform lens but the performance of the lens will limit the accuracy of the Fourier transform it performs. The skilled person understands how to use a lens to perform an optical Fourier transform.

### Hologram Calculation

In some embodiments, the computer-generated hologram is a Fourier transform hologram, or simply a Fourier hologram or Fourier-based hologram, in which an image is reconstructed in the far field by utilising the Fourier transforming properties of a positive lens. The Fourier hologram is calculated by Fourier transforming the desired light field in the replay plane back to the lens plane. Computer-generated Fourier holograms may be calculated using Fourier transforms. Embodiments relate to Fourier holography and Gerchberg-Saxton type algorithms by way of example only. The present disclosure is equally applicable to Fresnel holography and Fresnel holograms which may be calculated by a similar method. In some embodiments, the hologram is a phase or phase-only hologram. However, the present disclosure is also applicable to holograms calculated by other techniques such as those based on point cloud methods. British patent application GB 2112213.0 filed 26 Aug. 2021, incorporated herein by reference, discloses example hologram calculation methods that may be combined with the present disclosure.

In some embodiments, there is provided a real-time engine arranged to receive image data and calculate holograms in real-time using the algorithm. In some embodiments, the image data is a video comprising a sequence of image frames. In other embodiments, the holograms are pre-calculated, stored in computer memory and recalled as needed for display on a SLM. That is, in some embodiments, there is provided a repository of predetermined holograms.

### Light Modulation

The display system comprises a display device defining the exit pupil of the display system. The display device is a spatial light modulator. The spatial light modulation may be a phase modulator. The display device may be a liquid crystal on silicon, “LCOS”, spatial light modulator.

### Light Channeling

The optical system disclosed herein is applicable to pupil expansion with any diffracted light field. In some embodiments, the diffracted light field is a holographic light field-that is, a complex light field that has been spatially modulated in accordance with a hologram of an image, not the image itself. In some embodiments, the hologram is a special type of hologram that angularly divides/channels the image content. This type of hologram is described further herein merely as an example of a diffracted light field that is compatible with the present disclosure. Other types of hologram may be used in conjunction with the display systems and light engines disclosed herein.

A display system and method are described herebelow, which comprise a waveguide pupil expander. As will be familiar to the skilled reader, the waveguide may be configured as a ‘pupil expander’ because it can be used to increase the area over (or, within) which the light emitted by a relatively small light emitter-such as a relatively small SLM or other pixelated display device as used in the arrangements described herein-can be viewed by a human viewer or other viewing system that is located at a distance, such as a relatively large distance, away from the light emitter. The waveguide achieves this by increasing the number of transmission points from which the light is output, towards the viewer. As a result, the light may be seen from a plurality of different viewer locations and, for example, the viewer may be able to move their head, and therefore their line of sight, whilst still being able to see the light from the light emitter. Thus, it can be said that the viewer's ‘eye-box’ or ‘eye-motion box’ is enlarged, through use of a waveguide pupil expander. This has many useful applications, for example but not limited to head-up displays, for example but not limited to automotive head-up displays.

A display system as described herein may be configured to guide light, such as a diffracted light field, through a waveguide pupil expander in order to provide pupil expansion in at least one dimension, for example in two dimensions. The diffracted light field may comprise light output by a spatial light modulator (SLM), such as an LCOS SLM. For example, that diffracted light field may comprise light that is encoded by a hologram displayed by the SLM. For example, that diffracted light field may comprise light of a holographically reconstructed image, corresponding to a hologram displayed by the SL M. The hologram may comprise a computer-generated hologram (CGH) such as, but not limited to, a point-cloud hologram, a Fresnel hologram, or a Fourier hologram. The hologram may be referred to as being a ‘diffractive structure’ or a ‘modulation pattern’. The SLM or other display device may be arranged to display a diffractive pattern (or, modulation pattern) that comprises the hologram and one or more other elements such as a software lens or diffraction grating, in a manner that will be familiar to the skilled reader.

The hologram may be calculated to provide channelling of the diffracted light field. This is described in detail in each of GB2101666.2, GB2101667.0, and GB2112213.0, all of which are incorporated by reference herein. In general terms, the hologram may be calculated to correspond to an image that is to be holographically reconstructed. That image, to which the hologram corresponds, may be referred to as an ‘input image’ or a ‘target image’. The hologram may be calculated so that, when it is displayed on an SLM and suitably illuminated, it forms a light field (output by the SLM) that comprises a cone of spatially modulated light. In some embodiments the cone comprises a plurality of continuous light channels of spatially modulated light that correspond with respective continuous regions of the image. However, the present disclosure is not limited to a hologram of this type.

Although we refer to a ‘hologram’ or to a ‘computer-generated hologram (CGH)’ herein, it will be appreciated that an SLM may be configured to dynamically display a plurality of different holograms in succession or according to a sequence. The systems and methods described herein are applicable to the dynamic display of a plurality of different holograms.

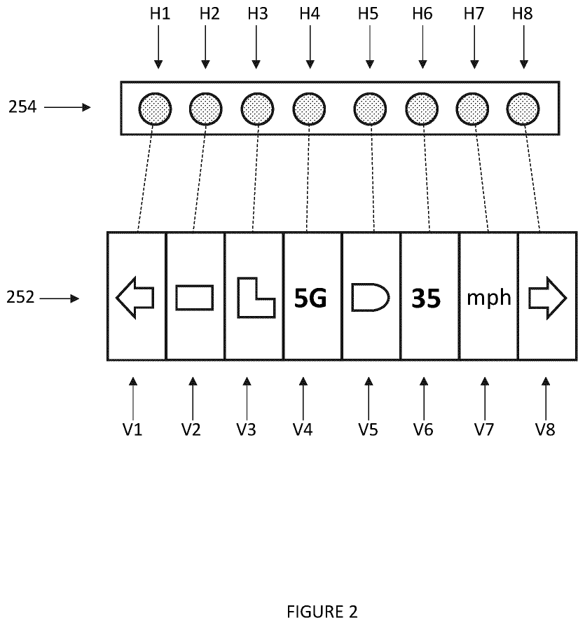

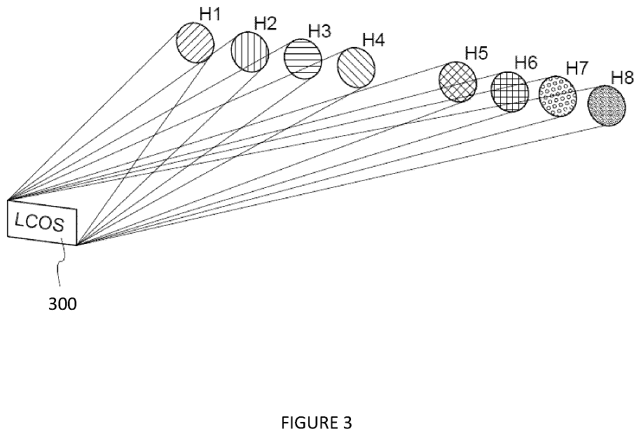

FIGS. 2 and 3 show an example of a type of hologram that may be displayed on a display device such as an SLM, which can be used in conjunction with a pupil expander as disclosed herein. However, this example should not be regarded as limiting with respect to the present disclosure.

FIG. 2 shows an image 252 for projection comprising eight image areas/components, V1 to V8. FIG. 2 shows eight image components by way of example only and the image 252 may be divided into any number of components. FIG. 2 also shows an encoded light pattern 254 (i.e., hologram) that can reconstruct the image 252—e.g., when transformed by the lens of a suitable viewing system. The encoded light pattern 254 comprises first to eighth sub-holograms or components, H1 to H8, corresponding to the first to eighth image components/areas, V1 to V8. FIG. 2 further shows how a hologram may decompose the image content by angle. The hologram may therefore be characterised by the channelling of light that it performs. This is illustrated in FIG. 3. Specifically, the hologram in this example directs light into a plurality of discrete areas. The discrete areas are discs in the example shown but other shapes are envisaged. The size and shape of the optimum disc may, after propagation through the waveguide, be related to the size and shape of the entrance pupil of the viewing system.

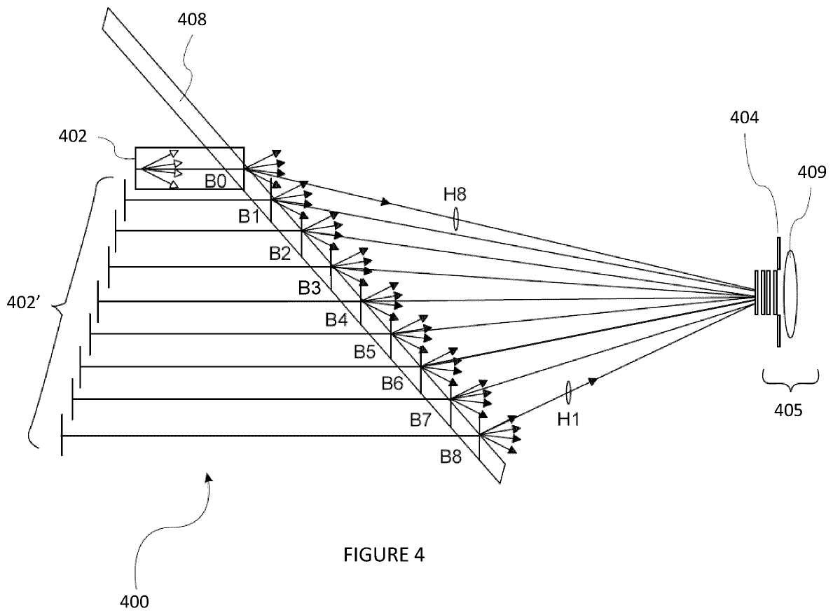

FIG. 4 shows a system 400, including a display device that displays a hologram that has been calculated as illustrated in FIGS. 2 and 3.

The system 400 comprises a display device, which in this arrangement comprises an LCOS 402. The LCOS 402 is arranged to display a modulation pattern (or ‘diffractive pattern’) comprising the hologram and to project light that has been holographically encoded towards an eye 405 that comprises a pupil that acts as an aperture 404, a lens 409, and a retina (not shown) that acts as a viewing plane. There is a light source (not shown) arranged to illuminate the LCOS 402. The lens 409 of the eye 405 performs a hologram-to-image transformation. The light source may be of any suitable type. For example, it may comprise a laser light source.

The viewing system 400 further comprises a waveguide 408 positioned between the LCOS 402 and the eye 405. The presence of the waveguide 408 enables all angular content from the LCOS 402 to be received by the eye, even at the relatively large projection distance shown. This is because the waveguide 408 acts as a pupil expander, in a manner that is well known and so is described only briefly herein.

In brief, the waveguide 408 shown in FIG. 4 comprises a substantially elongate formation. In this example, the waveguide 408 comprises an optical slab of refractive material, but other types of waveguide are also well known and may be used. The waveguide 408 is located so as to intersect the light cone (i.e., the diffracted light field) that is projected from the LCOS 402, for example at an oblique angle. In this example, the size, location, and position of the waveguide 408 are configured to ensure that light from each of the eight ray bundles, within the light cone, enters the waveguide 408. Light from the light cone enters the waveguide 408 via its first planar surface (located nearest the LCOS 402) and is guided at least partially along the length of the waveguide 408, before being emitted via its second planar surface, substantially opposite the first surface (located nearest the eye). As will be well understood, the second planar surface is partially reflective, partially transmissive. In other words, when each ray of light travels within the waveguide 408 from the first planar surface and hits the second planar surface, some of the light will be transmitted out of the waveguide 408 and some will be reflected by the second planar surface, back towards the first planar surface. The first planar surface is reflective, such that all light that hits it, from within the waveguide 408, will be reflected back towards the second planar surface. Therefore, some of the light may simply be refracted between the two planar surfaces of the waveguide 408 before being transmitted, whilst other light may be reflected, and thus may undergo one or more reflections, (or ‘bounces’) between the planar surfaces of the waveguide 408, before being transmitted.

FIG. 4 shows a total of nine “bounce” points, B0 to B8, along the length of the waveguide 408. Although light relating to all points of the image (V1-V8) as shown in FIG. 2 is transmitted out of the waveguide at each “bounce” from the second planar surface of the waveguide 408, only the light from one angular part of the image (e.g. light of one of V1 to V8) has a trajectory that enables it to reach the eye 405, from each respective “bounce” point, B0 to B8. Moreover, light from a different angular part of the image, V1 to V8, reaches the eye 405 from each respective “bounce” point. Therefore, each angular channel of encoded light reaches the eye only once, from the waveguide 408, in the example of FIG. 4.

The methods and arrangements described above can be implemented in a variety of different applications and viewing systems. For example, they may be implemented in a head-up-display (HUD) or in a head or helmet mounted device (HMD) such as an Augmented Reality (AR) HMD.

Although virtual images, which require the eye to transform received modulated light in order to form a perceived image, have generally been discussed herein, the methods and arrangements described herein can be applied to real images.

### Two-Dimensional Pupil Expansion

Whilst the arrangement shown in FIG. 4 includes a single waveguide that provides pupil expansion in one dimension, pupil expansion can be provided in more than one dimension, for example in two dimensions. Moreover, whilst the example in FIG. 4 uses a hologram that has been calculated to create channels of light, each corresponding to a different portion of an image, the present disclosure and the systems that are described herebelow are not limited to such a hologram type.

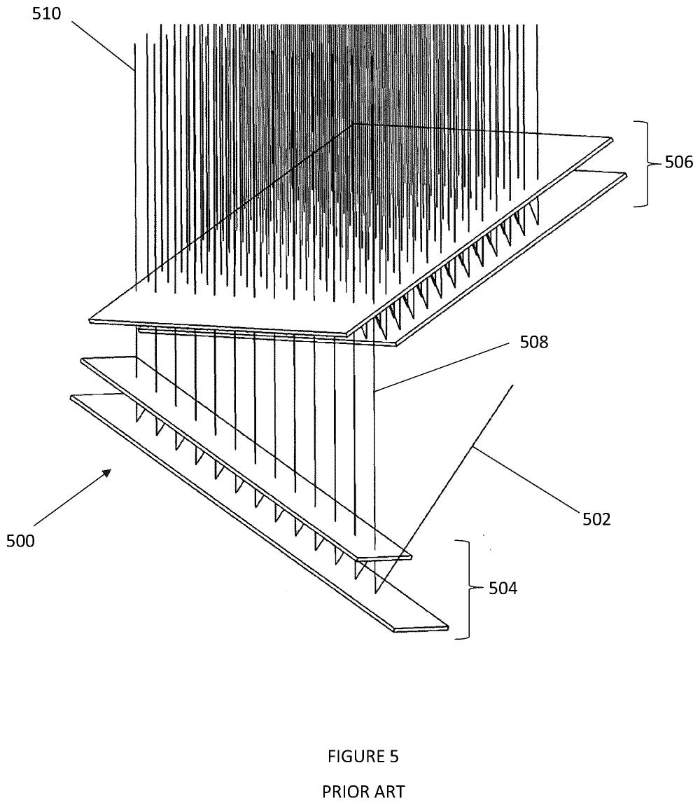

FIG. 5 shows a perspective view of a system 500 comprising two replicators, 504, 506 (or pupil expanders) arranged for expanding (or otherwise referred to as replicated) a light beam 502 each in a different dimension, such that the light beam is expanded in two dimensions.

In the system 500 of FIG. 5, the first replicator 504 comprises a first pair of surfaces, stacked parallel to one another, and arranged to provide replication—or, pupil expansion—in a similar manner to the waveguide 408 of FIG. 4. The first pair of surfaces are similarly (in some cases, identically) sized and shaped to one another and are substantially elongate in one direction. The collimated light beam 502 is directed towards an input on the first replicator 504. Due to a process of internal reflection between the two surfaces, and partial transmission of light from each of a plurality of output points on one of the surfaces (the upper surface, as shown in FIG. 5), which will be familiar to the skilled reader, light of the light beam 502 is replicated in a first direction, along the length of the first replicator 504. Thus, a first plurality of replica light beams 508 is emitted from the first replicator 504, towards the second replicator 506.

The second replicator 506 comprises a second pair of surfaces stacked parallel to one another, arranged to receive each of the collimated light beams of the first plurality of light beams 508 and further arranged to provide replication—or, pupil expansion—by expanding each of those light beams in a second direction, substantially orthogonal to the first direction. The first pair of surfaces are similarly (in some cases, identically) sized and shaped to one another and are substantially rectangular. The rectangular shape is implemented for the second replicator in order for it to have length along the first direction, in order to receive the first plurality of light beams 508, and to have length along the second, orthogonal direction, in order to provide replication in that second direction. Due to a process of internal reflection between the two surfaces, and partial transmission of light from each of a plurality of output points on one of the surfaces (the upper surface, as shown in FIG. 5), light of each light beam within the first plurality of light beams 508 is replicated in the second direction. Thus, a second plurality of light beams 510 is emitted from the second replicator 506, wherein the second plurality of light beams 510 comprises replicas of the input light beam 502 along each of the first direction and the second direction. Thus, the second plurality of light beams 510 may be regarded as comprising a two-dimensional grid, or array, of replica light beams.

Thus, it can be said that the first and second replicators 504, 505 of FIG. 5 combine to provide a two-dimensional replicator (or, “two-dimensional pupil expander”).

### Turning Layer

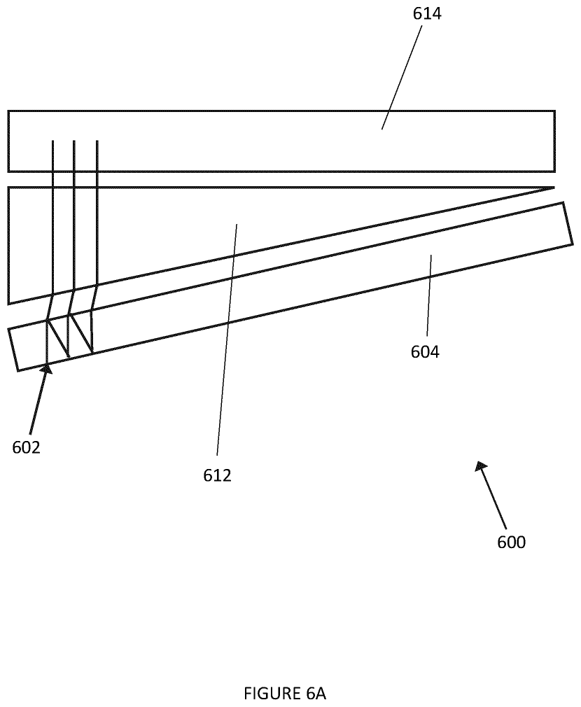

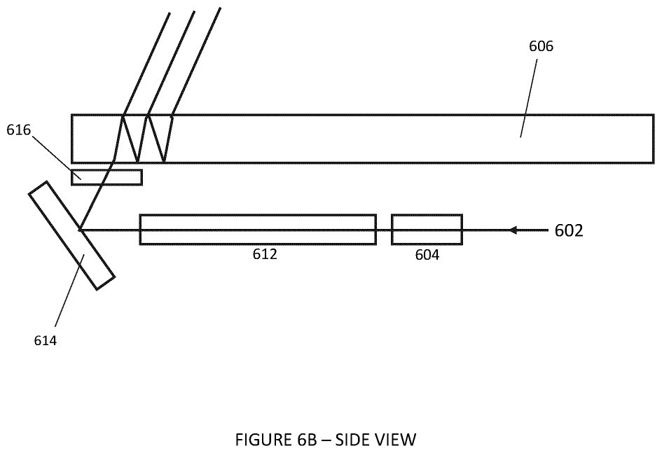

FIGS. 6A and 6B illustrate a pupil replication system 600 in accordance with some embodiments. The pupil replication system 600 comprises a first replicator 604, a second replicator 606 (not shown in FIG. 6A), a triangular wedge 612, and a turn mirror 614. Diffracted input light 602 is coupled into the first replicator 604 at an acute angle of incidence in order to cause light to propagate along the first replicator 604 and therefore allow for pupil expansion. The first replicator 604 and the second replicator 606 are waveguides, each waveguide configured to expand light in a single dimension. The first replicator 604 and the second replicator 606 act together to expand or replicate the exit pupil of the display in a horizontal and vertical dimension, such that the eye box or viewing area is increased.

Turn mirror 614 directs light towards the second replicator 606 (not shown in FIG. 6A). The triangular wedge 612 is located in an optical path between the turn mirror 614 and the first replicator 602. The triangular wedge 612 imparts a change in angle of the rays exiting the first replicator 612 in order to enable stacking of the replicated pupils in the second replicator 606. The triangular wedge 612 is a prism comprising at least two optical surfaces. An optical surface is a surface is a surface of the prism that is intended to receive or transmit light.

FIG. 6B illustrates a side view of the pupil replication system 600 as described in relation to FIG. 6A. An aperture device 616 is shown located in front of the input region of the second replicator 606. The aperture device 616 may be used to prevent cross-talk between channels, as described in GB2108456.1 filed on 14 Jun. 2021, the contents of which are herein incorporated by reference. The aperture device 616 may also be referred to as a switching device.

As can be seen in FIGS. 6A and 6B and in general, propagation refers to a general or group direction of light propagation in the waveguide. The direction of propagation may also be referred to as the optical axis (or plane) of the waveguide.

The triangular wedge 612 adds mass to the pupil replication system 600, and may also increase the gap between the first replicator 604 and the second replicator 606. The inventors have recognised that it may be replaced by an optical element comprising a turning layer. The turning layer may be conveniently applied to the aperture device 616, or another component in the system.

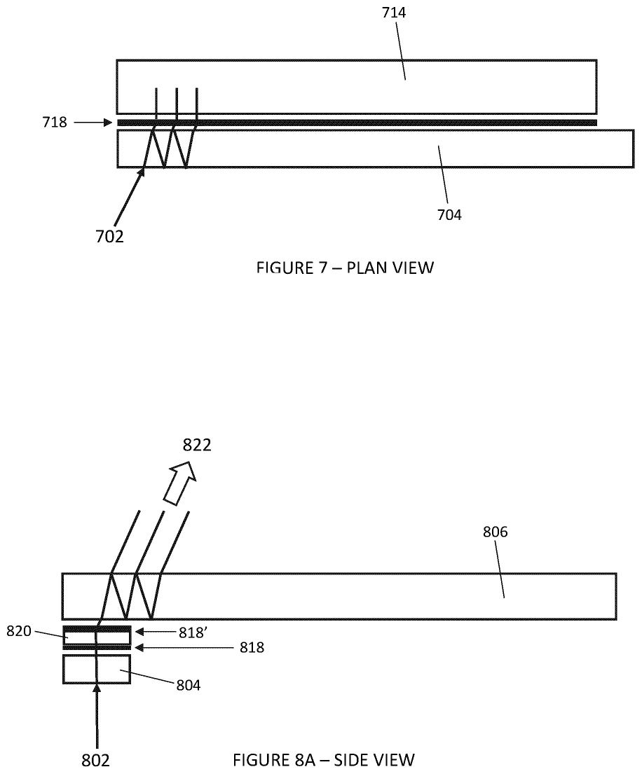

A system comprising a turning element is illustrated in FIG. 7. The system is similar to the system shown in FIGS. 6A and 6B, where the triangular wedge 612 is replaced by an optical element 718 comprising a turning layer. The system comprises a first replicator 704, the first replicator 704 configured to replicate a pupil of light such that the eye box or viewing area is expanded in a first dimension. In order to achieve the replication or ‘bounce’, diffracted light 702 may be input at an acute angle relative to the optical axis of the first replicator 704.

The turning layer of the optical element 718 turns the ray direction of light output from first replicator 704 such that light is correctly orientated to be input into fold mirror 714 and in turn a second replicator (not shown in FIG. 7). The second replicator is configured to replicate light such that the eye box or viewing area is expanded in a second dimension orthogonal to the first dimension.

The use of a turning layer allows the turn mirror 714 and first replicator to be oriented substantially parallel, reducing the volume of the system. This may be particularly useful when the system is used in a part of HUD system in a vehicle, where space may be limited. The replacement of the triangular wedge 612 also allows for the first replicator 704 and the fold mirror 714 to be located closer together. Reducing the space between devices not only reduces the volume, but also improves coupling between devices. Light will diverge when passing through an air gap, so reducing the gap reduces the amount of dispersion and therefore improves the overall efficiency of the system.

A second replicator (not shown in FIG. 7) receives light from turn mirror 714 and outputs light towards an output. The output may comprise a user, or may comprise a combiner or other type of display screen.

In some embodiments the turning layer may comprise a prismatic layer, such as a layer of microstructures. In some embodiments the turning layer may be applied to the optical element 718. In some embodiments the turning layer may be formed directly on the optical element 718, for example by an etching process. In some embodiments the prismatic layer may be formed separate from the optical element 718 then bonded to the optical element 718.

FIG. 8A illustrates an alternative system according to some embodiments. The alternative system is similar to the system shown in FIG. 7, where that the optical element 718 comprises a switching device 820. The switching device 820 may be used to prevent cross-talk between channels, as described in GB2108456.1 filed on 14 Jun. 2021, the contents of which are herein incorporated by reference.

Diffracted light 802 is input into first replicator 804 at an acute angle relative to the optical axis of the first replicator 804. Light in first replicator 804 propagates along the first replicator 804 and is replicated such that the eye box or viewing area is expanded in a first dimension.

Light is output by the first replicator 804 at an acute angle towards the switching device 820. The switching device 820 is used to prevent cross talk between channels and may be particularly useful when using holographic or diffraction-based systems as described in more detail in GB2108456.1.

A turning layer may be applied in two parts to the switching device 820, the first turning layer 818 may be applied to the part of the switching device 820 facing the output of the first replicator 804, and the first turning layer 818 may be configured to turn a ray direction of the light output from the first replicator 804 such that the angle is correct for input into the second replicator 806. As can be recognised from the description, the first turning layer performs substantially the same function as the triangular wedge 612 shown in FIGS. 6A and 6B.

A second turning layer 818′ is applied to the part of the switching device 820 facing the input of the second replicator 806. Light in the second replicator 806 propagates along the second replicator 806 and is replicated such that the eye box or viewing area is expanded in a second dimension, orthogonal to the first dimension. The second turning layer 818′ turns the rays exiting the switching device 820 towards the input area of the second replicator 806. The turning direction of the second turning layer 818′ may be orthogonal to the turning direction of the first turning layer 818. As can be recognised from the description, the second turning layer 818′ performs substantially the same function as the fold mirror 714 as shown in FIG. 7A.

The second replicator 806 outputs light towards an output 822. The output may comprise a user, or may comprise a combiner or other type of display screen.

The alternative system described with reference to FIGS. 8A and 8B replaces both the triangular wedge 612 and the turning mirror 614 shown in FIG. 6B. This may result in a less bulky and lighter system in comparison to both the system of FIGS. 6A, 6B and 7. Furthermore, the first replicator 604 and the second replicator 606 may be located closer together increasing the coupling efficiency and the quality of the image displayed to the user.

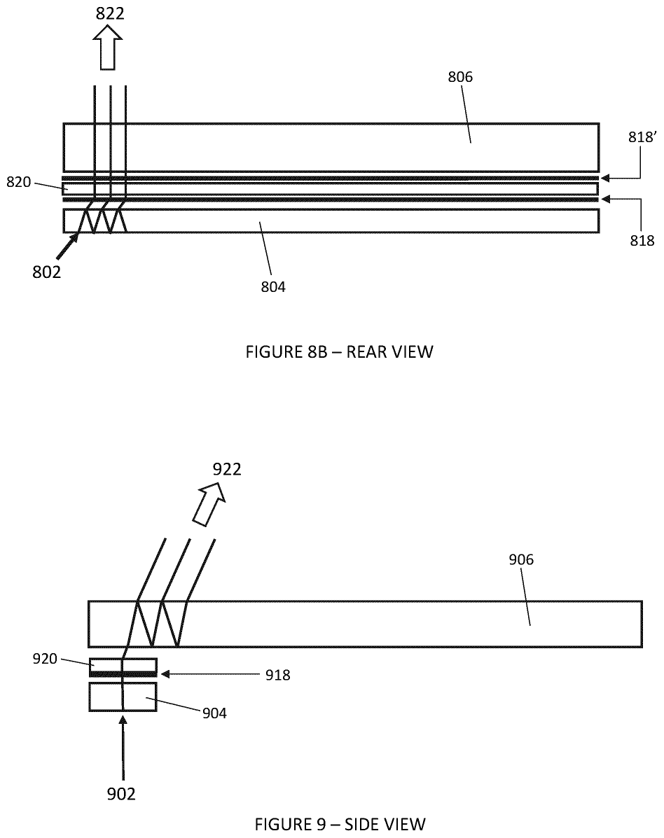

FIG. 9 illustrates another alternative device, comprising a first replicator 904 to receive input diffracted light 902 and replicate the light such that the eye box or viewing area is expanded in a first dimension. Light is output towards a switching device 920 comprising a turning layer 918. Turning layer 918 performs the function of turning mirror 614 and triangular wedge 612. Turning layer 918 both sets the appropriate angle into the second replicator 906 and turns the light towards the second replicator 906. Second replicator replicates 906 light such that the eye box or viewing area is expanded in a second dimension orthogonal to the first dimension.

The second replicator 906 outputs light towards an output 922. The output may comprise a user, or may comprise a combiner or other type of display screen.

The device illustrated in FIG. 9 is substantially similar to the alternative device described with relation to FIGS. 8A and 8B, where the first turning layer and second turning layer are applied as the turning layer 922 in a single layer. The turning layer 922 may comprise two layers formed on top of each other, forming a single layer. The single layer may be etched in one or more discrete processes.

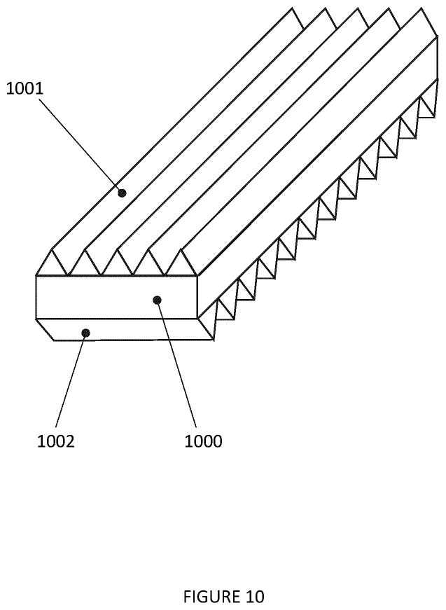

FIG. 10 illustrates an optical element 1000 comprising two turning layers in accordance with some embodiments. A first turning layer 1001 and a second turning layer 1002 sandwich a liquid crystal cell which may be the switching or control device of the present disclosure. Each turning layer comprises an array of prismatic elements, which may be prismatic microstructures. The prismatic elements are arranged such that at least one of the optical surfaces of the prismatic elements of the first turning layer 1001 is orthogonal to at least one of the optical surfaces prismatic elements of the second turning layer 1002. Alternatively, it could be described as the prismatic elements of the first turning layer being orthogonal to the prismatic elements of the second turning layer.

In some embodiments the input surfaces of the prismatic elements of the first layer may be orthogonal to the output surfaces of the prismatic elements of the second layer.

A switching device as described with relation to FIGS. 8A and 8B could be in an optical path between the first turning layer 1001 and the second turning layer 1002. In some embodiments the switching device could be formed as part of the substrate.

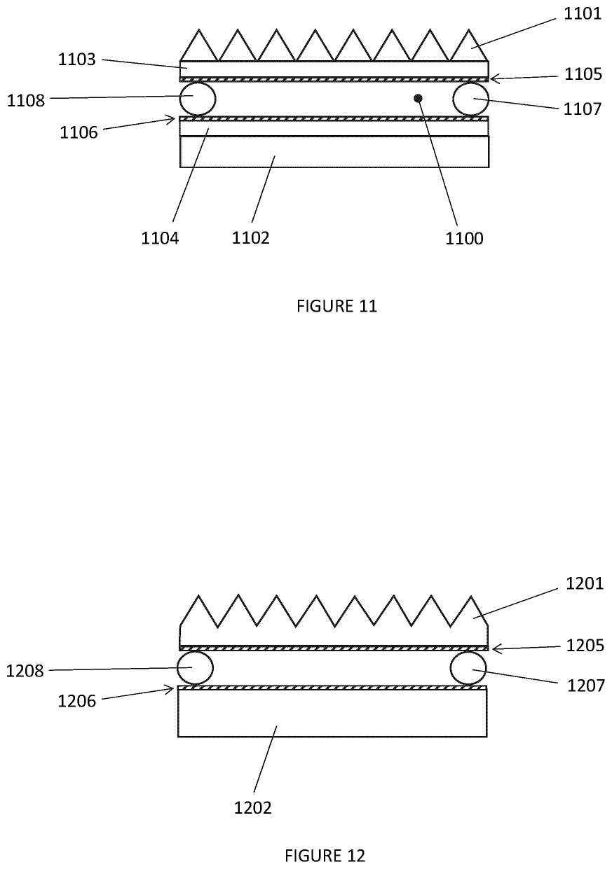

FIG. 11 illustrates an optical device in accordance with some embodiments. The optical device is similar to that of FIG. 10, however the substrate comprises a liquid crystal layer 1100 and spacers such as spacer 1107 and 1108. The liquid crystal layer 1100 may be surrounded by a casing layer 1103, 1104, such as cover glass or other suitable casing material. The casing layer 1103, 1104 encase the liquid crystal in the device. The optical device also comprises a first and second electrodes 1104, 1106.

The prismatic structures of the first and second turning layers 1101, 1102 may be etched or may be formed on the casing layers 1103, 1104 by another process, such as by deposition. Alternatively, the prismatic structures of the first and second turning layers 1101, 1102 may be formed separate from the casing layers (e.g. cover glass) 1103, 1104 and bonded to the casing layers (e.g. cover glass) 1103, 1104.

A transparent conducting material, such as indium tin oxide (ITO) may be used as the first and second electrode 1107, 1108. The electrodes allows the individual cells of the optical device to be switched and may be described as a transparent electrodes. The optical device may also comprise at least one non-transparent electrode.

FIG. 12 illustrates a device that is similar to the optical device of FIG. 11, where the prismatic layers are formed directly on the casing layers (e.g. cover glass) 1201, 1202 of the liquid crystal device. The device also comprises first and second electrodes 1205, 1206, and spacers such as spacer 1207, 1208. Forming the prismatic layers directly on the casing layers (e.g. cover glass) 1201, 1202 may reduce the number of processing steps required to produce the device, and decrease the number of components in turn reducing the size of the device. It may also simplify any alignment of the device and layers. Forming the prismatic layers directly on the casing layer 1201, 1202 may comprise etching.

FIGS. 11 and 12 illustrate an optical element that may be switched using liquid crystals. However other types of switching devices may be produced. For example, a switching device using microelectromechanical systems (MEMS) device may be used. A suitable MEMS device may comprise an array of switchable mirrors. Switching of the mirrors may switch light from being directed towards the input region of the second replicator to being directed towards a region where light remains uncoupled into the second replicator. In some embodiments this may comprise a light dump area. In some embodiments the light may be directed towards a sensor or an array of sensors. This may allow for integrity monitoring of the display. An appropriate action may be taken if the sensor detects that the integrity of the display is below a pre-defined limit.

The switching device as described with relation to some embodiments may switch based on an output of an eye tracker. The eye tracker may determine where the user is looking at, and the appropriate areas of switching device may be switched.

In some embodiments the light field is described as being a diffracted light field (or holographic), however it is to be understood that the systems described may be applicable to other types of light fields which are not diffracted light fields.

In some embodiments the turning layer is described as being a prismatic layer, however it is to be understood the other suitable types of turning layers may be used. The thickness of the turning layer may be between 10 μm and 1000 μm, alternatively the thickness may be between 100 μm and 1000 μm. However, the thickness is not limited to the aforementioned ranges.

In some embodiments, the diffracted light field comprises diverging ray bundles. In some embodiments, the image formed by the diffracted light field is a virtual image.

There is disclosed herein a display system that forms an image using diffracted light and provides an eye-box size and field of view suitable for real-world application—e.g. in the automotive industry by way of a head-up display. The diffracted light is light forming a holographic reconstruction of the image from a diffractive structure—e.g. hologram such as a Fourier or Fresnel hologram. The use diffraction and a diffractive structure necessitates a display device with a high density of very small pixels (e.g. 1 micrometer)-which, in practice, means a small display device (e.g. 1 cm). The inventors have addressed a problem of how to provide 2D pupil expansion with a diffracted light field e.g. diffracted light comprising diverging (not collimated) ray bundles.

In aspects, the display system comprises a display device-such as a pixelated display device, for example a spatial light modulator (SLM) or Liquid Crystal on Silicon (LCOS) SLM—which is arranged to provide or form the diffracted or diverging light. In such aspects, the aperture of the spatial light modulator (SLM) is a limiting aperture of the system. That is, the aperture of the spatial light modulator—more specifically, the size of the area delimiting the array of light modulating pixels comprised within the SLM-determines the size (e.g. spatial extent) of the light ray bundle that can exit the system. In accordance with this disclosure, it is stated that the exit pupil of the system is expanded to reflect that the exit pupil of the system (that is limited by the small display device having a pixel size for light diffraction) is made larger or bigger or greater in spatial extend by the use of at least one pupil expander.

The diffracted or diverging light field may be said to have “a light field size”, defined in a direction substantially orthogonal to a propagation direction of the light field. Because the light is diffracted/diverging, the light field size increases with propagation distance.

In some embodiments, the diffracted light field is spatially-modulated in accordance with a hologram. In other words, in such aspects, the diffractive light field comprises a “holographic light field”. The hologram may be displayed on a pixelated display device. The hologram may be a computer-generated hologram (CGH). It may be a Fourier hologram or a Fresnel hologram or a point-cloud hologram or any other suitable type of hologram. The hologram may, optionally, be calculated so as to form channels of hologram light, with each channel corresponding to a different respective portion of an image that is intended to be viewed (or perceived, if it is a virtual image) by the viewer. The pixelated display device may be configured to display a plurality of different holograms, in succession or in sequence. Each of the aspects and embodiments disclosed herein may be applied to the display of multiple holograms.

The output port of the first waveguide pupil expander may be coupled to an input port of a second waveguide pupil expander. The second waveguide pupil expander may be arranged to guide the diffracted light field—including some of, preferably most of, preferably all of, the replicas of the light field that are output by the first waveguide pupil expander—from its input port to a respective output port by internal reflection between a third pair of parallel surfaces of the second waveguide pupil expander.

The first waveguide pupil expander may be arranged to provide pupil expansion, or replication, in a first direction and the second waveguide pupil expander may be arranged to provide pupil expansion, or replication, in a second, different direction. The second direction may be substantially orthogonal to the first direction. The second waveguide pupil expander may be arranged to preserve the pupil expansion that the first waveguide pupil expander has provided in the first direction and to expand (or, replicate) some of, preferably most of, preferably all of, the replicas that it receives from the first waveguide pupil expander in the second, different direction. The second waveguide pupil expander may be arranged to receive the light field directly or indirectly from the first waveguide pupil expander. One or more other elements may be provided along the propagation path of the light field between the first and second waveguide pupil expanders.

The first waveguide pupil expander may be substantially elongated and the second waveguide pupil expander may be substantially planar. The elongated shape of the first waveguide pupil expander may be defined by a length along a first dimension. The planar, or rectangular, shape of the second waveguide pupil expander may be defined by a length along a first dimension and a width, or breadth, along a second dimension substantially orthogonal to the first dimension. A size, or length, of the first waveguide pupil expander along its first dimension make correspond to the length or width of the second waveguide pupil expander along its first or second dimension, respectively. A first surface of the pair of parallel surfaces of the second waveguide pupil expander, which comprises its input port, may be shaped, sized, and/or located so as to correspond to an area defined by the output port on the first surface of the pair of parallel surfaces on the first waveguide pupil expander, such that the second waveguide pupil expander is arranged to receive each of the replicas output by the first waveguide pupil expander.

The first and second waveguide pupil expander may collectively provide pupil expansion in a first direction and in a second direction perpendicular to the first direction, optionally, wherein a plane containing the first and second directions is substantially parallel to a plane of the second waveguide pupil expander. In other words, the first and second dimensions that respectively define the length and breadth of the second waveguide pupil expander may be parallel to the first and second directions, respectively, (or to the second and first directions, respectively) in which the waveguide pupil expanders provide pupil expansion. The combination of the first waveguide pupil expander and the second waveguide pupil expander may be generally referred to as being a “pupil expander”.

It may be said that the expansion/replication provided by the first and second waveguide expanders has the effect of expanding an exit pupil of the display system in each of two directions. An area defined by the expanded exit pupil may, in turn define an expanded eye-box area, from which the viewer can receive light of the input diffracted or diverging light field. The eye-box area may be said to be located on, or to define, a viewing plane.

The two directions in which the exit pupil is expanded may be coplanar with, or parallel to, the first and second directions in which the first and second waveguide pupil expanders provide replication/expansion. Alternatively, in arrangements that comprise other elements such as an optical combiner, for example the windscreen (or, windshield) of a vehicle, the exit pupil may be regarded as being an exit pupil from that other element, such as from the windscreen. In such arrangements, the exit pupil may be non-coplanar and non-parallel with the first and second directions in which the first and second waveguide pupil expanders provide replication/expansion. For example, the exit pupil may be substantially perpendicular to the first and second directions in which the first and second waveguide pupil expanders provide replication/expansion.

The viewing plane, and/or the eye-box area, may be non-coplanar or non-parallel to the first and second directions in which the first and second waveguide pupil expanders provide replication/expansion. For example, a viewing plane may be substantially perpendicular to the first and second directions in which the first and second waveguide pupil expanders provide replication/expansion.

In order to provide suitable launch conditions to achieve internal reflection within the first and second waveguide pupil expanders, an elongate dimension of the first waveguide pupil expander may be tilted relative to the first and second dimensions of the second waveguide pupil expander.

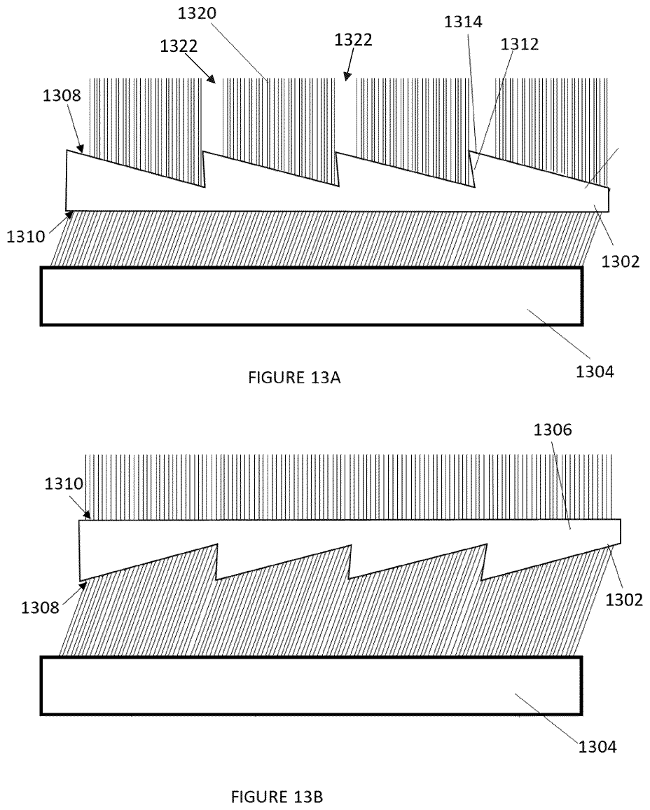

Through simulation and experimentation, the inventors have found that, in some arrangements, the use of a prismatic layer as a turning layer may introduce artefacts in the turned light. These artefacts could include dark bands, stray light rays and/or breaks in the coherence of the turned light. FIGS. 13A, 13B, 14, 15A and 15B show embodiments of systems comprising prismatic turning layers which reduce the effects of these artefacts.

FIG. 13A shows a system comprising a first replicator 1304 and a prismatic turning layer 1302. FIG. 13A is a side view showing the profile of the prismatic turning layer 1302. The prismatic turning layer 1302 comprises a plurality of individual prisms 1306 which are connected together/integrally formed. The prismatic turning layer 1302 comprises a transparent material. The prismatic turning layer 1302 comprises a first surface 1308 and a second surface 1310. The first surface 1308 has a serrated structure. Each serration of the serrated structure is formed by an individual prism 1306. In particular, each prism 1306 comprises a first face 1312 and a second face 1314 (the first and second faces appears as edges in FIG. 13A because FIG. 13A is a side view of the prismatic turning layer 1302. The first and second face 1312, 1314 of each prism 1306 are connected. Both the first face and the second face are angled with respect to the general plane of the prismatic turning layer 1302 (which is horizontal when viewed in FIG. 13A). A width of each first face is larger than a width of the second face. The second surface 1310 is substantially planar.

In FIG. 13A, light 1320 is incident on the substantially planar second surface 1310 of the prismatic turning layer. The light is transmitted through the prismatic turning layer and emitted out of the second surface. Because of the refractive index, and the serrated nature of the first surface 1308, the light that is emitted by the first surface 1308 is turned relative to the light that is received by the second surface 1310.

Generally, the first face 1312 of each prism 1306 is angled such that the light rays are emitted out of the first face 1312. This is shown in FIG. 13A. However, a portion of the light may be incident on the second face 1314. The angle of the second face 1314 is such that this light may be scattered. Scattered rays (or stray light rays) are not shown in FIG. 13A, but it should be understood that these scattered or stray rays are not emitted parallel to the other rays. This causes dark bands 1322 in the light that is emitted out of the turning layer. This is clearly undesirable.

The inventors have found that the dark bands can be substantially reduced by orientating the turning layer such that first surface 1308 of the prismatic turning layer 1302 faces the first replicator 1304 and the second surface 1310 of the prismatic turning layer 1302 faces away from the first replicator 1304. In other words, the first surface 1308 is arranged to receive light from the first replicator 1304 and the second surface 1310 is arranged to emit the light. This is shown in FIG. 13B. The inventors have found through simulation and experimentation that this substantially eliminates darks bands in the emitted light.

The inventors have also found that applying a light absorbing material on each second face 1310 can reduce or minimise stray light beams because rays of light are absorbed before being scattered by the second face 1310. The light absorbing material is not shown in the drawings. In some embodiments, the light absorbing material can be applied to each second face 1310 as a coating.

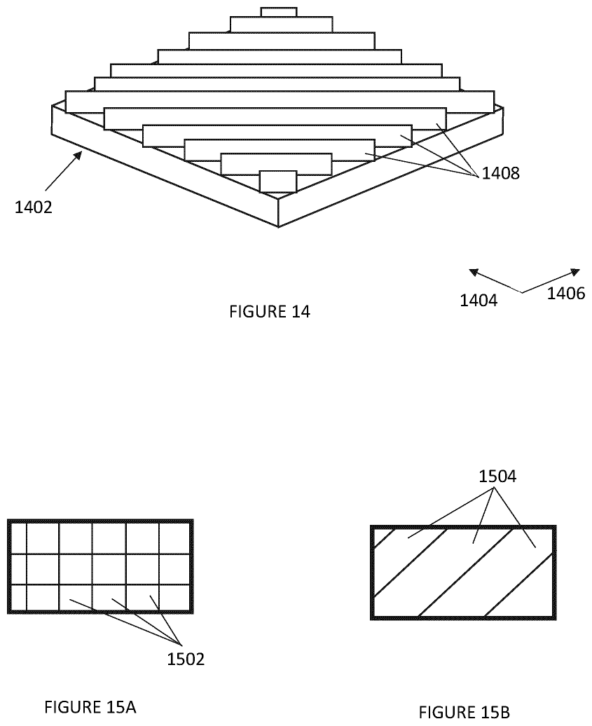

FIG. 14 shows a schematic perspective view of a second example of a single prismatic layer 1402. The single prismatic layer 1402 has a generally square shape. The generally square shape extends substantially in first and second orthogonal directions (represented by arrows 1404, 1406 in FIG. 14). The prismatic layer 1402 comprises a plurality of individual prisms 1408, similar to the example shown in FIG. 10. However, the prisms 1408 of the second example are arranged substantially diagonally. In particular, the prisms 1408 of the second example extend substantially in a third direction that is not parallel to either of the first or second directions 1404,1406. Such an arrangement of prisms 1408 allows for a compound turn of the light input.

One advantage of the arrangement of the second example is that, compared to the example comprising first and second (orthogonal) prismatic layers, the light output by the turning layer has improved coherence. This is explained in more detail with respect to the FIGS. 15A and 15B.

Each prism breaks the coherence of light emitted by the turning layer. In particular, the light emitted from a single prism may be coherent with its self. But the light emitted from a first prism is not coherent with light emitted from a second prism. This results in strips or portions or regions of coherent light being output by the turning layer. The shape/arrangement of these portions of coherent light correspond to the arrangement of the prisms of the turning layer.

FIG. 15A represents a portion of light output by the turning layer shown in FIG. 10. The turning layer of FIG. 10 comprises two layers of prisms that are orthogonal to one another. As such, the regions of coherent light form a grid shape. Each region 1502 within the grid comprises coherent light.

FIG. 15B represents a portion of light output by the turning layer shown in FIG. 14. The turning layer of FIG. 14 comprises a single layer of prisms. As such, the regions of coherent light form a diagonal stripe shape. Each region 1504 within the diagonal stripe shape comprises coherent light.

As is shown in FIGS. 15A and B, and as should be clear to the skilled person, the regions 1504 are larger than the regions 1502. Thus, the example in FIG. 15B has fewer, larger regions of coherent light and the example in FIG. 15A has more, smaller regions of coherent light. The inventors have recognised that the larger the regions of coherent light, the better the holographic reconstruction (in particular, the higher the resolution and smaller the pixels of the holographic reconstruction).

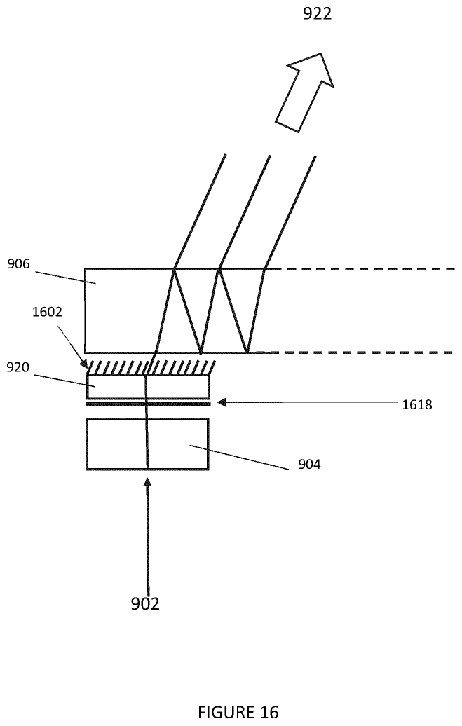

FIG. 16 illustrates another example of a device similar to the device of FIG. 9, and like features are numbered accordingly. For example, FIG. 9 comprises a first replicator 904 to receive input diffracted light 902 and replicate the light such that the eye box or viewing area is expanded in a first dimension. Light is output towards a switching device 920. The switching device 920 comprises a turning layer 1318. The turning layer 1318 in this example comprises a diffractive optical element. Turning layer 1318 both sets the appropriate angle into the second replicator 906 and turns the light towards the second replicator 906. Second replicator replicates 906 light such that the eye box or viewing area is expanded in a second dimension orthogonal to the first dimension.

The second replicator 906 outputs light towards an output 922. The output may comprise a user, or may comprise a combiner or other type of display screen.

The turning layer 1618 (comprising a diffractive optical element) is arranged to receive light from the first replicator 904 (via the switching device 920) and to diffract the light. This forms a plurality of diffraction orders. The diffractive optical element is arranged such that the light is principally redirected into a first diffractive order. In some examples, this means that most (optionally more than 90% or even more than 95%) of the optical energy of each replica is redirected into the first diffractive order. So, the first diffractive order is by far the brightest diffractive order. Each first diffractive order is defined by a diffraction angle which is common to each replica because each replica has the same angle of incidence on the diffractive optical element. Because each replica is principally redirected into the first diffraction order, and other non-zero diffraction orders have negligible brightness/light energy.

The skilled person will be familiar with the fabrication of diffractive optical elements (DOEs). In particular, the skilled person will be familiar with fabricating diffractive optical elements comprising a volume hologram. In some embodiments, the diffractive optical element can be fabricated by exposing a photo-thermo-refractive glass to an interference pattern from a laser such as an ultraviolet laser. The interference pattern corresponds to the calculated or computed hologram. The diffractive optical element may be a volume phase hologram (VPH).

The skilled person will be familiar with the general concept of computing or calculating a hologram for a DOE such that the DOE has desired diffractive properties. In the specific context of this disclosure, the hologram recorded in the DOE is computed so as to turn or redirect light into a non-zero diffractive zero having a desired angle (with respect to a normal of the diffractive optical element) and a desired intensity. The hologram may be calculated or computed such that light at a first wavelength is turned or redirected into a non-zero diffractive order having the desired angle and/or such that a desired proportion of energy of a wavefront is re-directed into the respect non-zero diffractive order. In some embodiments, the hologram may be calculated or computed such that light at a first wavelength and light at a second wavelength is turned or redirected into the same respective non-zero diffractive order having substantially the same angle. In some embodiments, the hologram may be calculated or computed to achieve the same with a third wavelength also. The first, second and third wavelengths may correspond to red, green and blue (laser) light respectively. In this way, the same waveguide/diffractive optical element can be used for a full colour image and the light of the different wavelengths (in the respective common non-zero diffractive order) will substantially not diverge at an eye-box of the holographic projector. When the diffractive optical element comprises a hologram/diffractive pattern computed or calculated to diffract light of multiple wavelengths into a common non-zero diffractive order at the desired angle, the proportion of light re-directed into that order may be lower than when the hologram is optimized for a single wavelength. This is because it can be difficult to calculate or compute a hologram that redirects light at multiple wavelengths in exactly the same way. In some examples, having a common angle for the respective common non-zero diffractive order at each wavelength is more important than the efficiency of the diffraction into that common order. In such examples, the skilled person will understand that the efficiency of the diffractive optical element may need to be compromised when the diffractive optical element is arranged for multiple wavelengths.

In order to fabricate the DOE, the computed hologram is recorded as a volume hologram, for example as a volume phase hologram (VPH). The skilled person will be familiar with such recording.

In one example, a VPH grating can be made by depositing a thin film of photo-sensitive material onto a glass substrate. The photo-sensitive material may be dichromated gelatin (DCG). The use of DCG in the formation of VPH gratings is well known (see, for example, BARSDEN S. Volume-Phase Holographic Gratings and the Efficiency of Three Simple Volume-Phase Holographic Gratings. Publications of the Astronomical Society of the Pacific, 112:802 to 820, 2000 June—in particular page 812). In such examples, a VPH grating is made by depositing a thin film of sensitized DCG onto a glass substrate. A holographic exposure system is used to record an interferometrically produced wave pattern within the gelatin layer (the interferometrically produced wave pattern corresponding to the (computed) hologram described in the preceding paragraph). The grating is then processed resulting in a material density that translates to a specific value for the refractive index such that the original fringe pattern of the holographic exposure is imprinted into the grating as a modulation of its refractive index. Once desired grating parameters have been achieved, a glass cover is laminated onto the gelatin surface.

In another example, a VPH grating can be formed using one or more layers of a photo film such as Bayfol (Registered Trademark) HX120. Bayfol® HX120 is a light-sensitive photo film. Bayfol® HX120 film consists of a three layer stack of a substrate, a light-sensitive photopolymer and a protective cover film. A triacetate (TAC) substrate and a polyethylene terphthalate (PET) protective cover film are used. In order to record a hologram, the photopolymer film is laminated onto a glass plate. The holographic recording is done with two coherent and collimated laser beams which penetrate the prepared sample from two opposite sides. One of these beams is a signal beam and the other is a reference beam. The beams may interfere with one another to create an interference pattern corresponding to a hologram (similarly to the DCG approach disclosed above). The laser beams may cause photo-polymerization of the substrate. After the holographic recording, the material is bleached using a dose of ultraviolet light and, simultaneously, light having a wavelength in the visible range. After recording, the photopolymer film may be delaminated from the glass plate. In some embodiments, the VPH grating is formed in a single layer of the photo film. In such embodiments a single hologram may be computed and recorded in the single layer of photo film. In other embodiments, a plurality of layers photo films may be used to form the VPH grating. A (sub-) hologram may be recorded in each layer of photo film as described above. In particular, each layer of photo film may be laminated onto a glass substrate, a (sub-) hologram may be recorded using two laser beams, the photo film may then be bleached and de-laminated from the glass substrate. The process may be repeated for each layer of photo film. The plurality of layers of photo film (each comprising a recording of a sub-hologram) may then be stacked to together form the VPH. A different (sub-) hologram may be recorded in each layer of photo film. Each (sub-) hologram may be computed. As the skilled person will appreciate, the (sub-) holograms may be calculated such that a VPH having a desired performance is formed when the layers of photo-film are stacked up. In other words, each of the sub-holograms, when combined, may act as a volume hologram such as that recorded in DCG, as described above.

The device of FIG. 16 further comprises an array of louvres 1602. Each louvre of the array of louvres 1602 is parallel and angled to be parallel to the “turned” output light. In this way, light that has been redirected into the first diffractive order is transmitted through the louvre array. Thus, the array of louvres may be described as substantially transmissive at the first diffractive order angle. The zeroth order, however, is not parallel to the array of louvres. So, each zeroth diffractive order is incident on a louvre. The louvres are arranged to absorb the zeroth diffractive order light and so substantially prevent the zeroth diffractive order (noise) from reaching an eye-box. Thus, the louvre array may be described as being substantially non-transmissive at a zeroth diffraction angle of the diffractive optical element.

### Additional Features

The methods and processes described herein may be embodied on a computer-readable medium. The term “computer-readable medium” includes a medium arranged to store data temporarily or permanently such as random-access memory (RAM), read-only memory (ROM), buffer memory, flash memory, and cache memory. The term “computer-readable medium” shall also be taken to include any medium, or combination of multiple media, that is capable of storing instructions for execution by a machine such that the instructions, when executed by one or more processors, cause the machine to perform any one or more of the methodologies described herein, in whole or in part.

The term “computer-readable medium” also encompasses cloud-based storage systems. The term “computer-readable medium” includes, but is not limited to, one or more tangible and non-transitory data repositories (e.g., data volumes) in the example form of a solid-state memory chip, an optical disc, a magnetic disc, or any suitable combination thereof. In some example embodiments, the instructions for execution may be communicated by a carrier medium. Examples of such a carrier medium include a transient medium (e.g., a propagating signal that communicates instructions).

It will be apparent to those skilled in the art that various modifications and variations can be made without departing from the scope of the appended claims. The present disclosure covers all modifications and variations within the scope of the appended claims and their equivalents.

### There is Also Provided the Following List of Numbered Clauses:

Item 1. A system comprising:
   a first replicator arranged to receive a diffracted light field and replicate the diffracted light field in a first direction;
   a second replicator arranged to receive output light from the first replicator and replicate the diffracted light field in a second direction, the second direction substantially perpendicular to the first direction; and
   an optical element comprising a turning layer, the optical element arranged to optically-couple output light from the first replicator to an input of the second replicator, wherein the turning layer is arranged to turn output light from the first replicator.
Item 2. The system according to item 1, wherein the turning layer turns the ray direction such that an overall propagation direction of the output light from the first replicator is normal to an exit surface of the first replicator.
Item 3. The system according to item 1 or 2, wherein the turning layer turns the ray direction such that the rays incident on the input of the second replicator are at an acute angle in a first plane of the second replicator such that the diffracted light field is replicated by the second replicator parallel to the first plane.
Item 4. The system according to any preceding items, wherein the optical element comprises a second turning layer, wherein the second turning layer is arranged to turn the output light in a direction that is orthogonal to the direction turned by the turning layer.
Item 5. The system according to item 4, wherein the turning layer and the second turning layer comprise a single layer.
Item 6. The system according to item 4, wherein the turning layer and the second turning layer are opposing.
Item 7. The system according to any preceding items, wherein the diffracted light field comprises a holographic light field.
Item 8. The system according to any preceding items, wherein the diffracted light field is generated from a spatial light modulator.
Item 9. The system according to any preceding items, wherein the second replicator receives light at an acute angle of incidence relative to the propagation along the second replicator.
Item 10. The system according to any preceding items, wherein the optical element is arranged on the first replicator, the second replicator or a combination of the first replicator and the second replicator.
Item 11. The system according to item 10, wherein the turning layer is arranged on the output of the first replicator.
Item 12. The system according to item 10, wherein the turning layer is arranged on the second replicator.
Item 13. The system according to item 4, or any preceding claim dependent upon item 4, wherein the second turning layer is arranged on the input of the second replicator.
Item 14. The system according to any preceding items, wherein the optical element is an aperture device, arranged to selectively block parts of the diffracted light beam to reduce cross-talk.
Item 15. The system according to any preceding items, wherein the turning layer is etched into the surface of the optical element.
Item 16. The system according to any preceding items, wherein the turning layer comprises an array of microstructures.
Item 17.A device comprising:
   a 1D array of cells, wherein each cell is independently switchable between a first state and a second state; and
   at least one turning layer arranged to change the direction of the transmitted light; wherein
   each cell is configured to receive diffracted light from an output region of a first replicator and:
      in the first state output the diffracted light towards an input region of a second replicator;
      In the second state the diffracted light remains uncoupled into the second replicator.
Item 18. The device according to item 17, wherein the device is a liquid crystal device.
Item 19. The device according to items 17 or 18 wherein each cell is substantially transparent in first state, and substantially opaque in the second state.
Item 20. The device according to any of items 17-19, wherein the device comprises a first transparent substrate configured to receive diffracted light and a second transparent substrate configured to output light, and wherein the 1D array of cells is located in an optical path between the first transparent substrate and the second transparent substrate and the at least one turning layer is arranged on at least one of the first transparent substrate and the second transparent substrate.
Item 21. The device according to items 17, wherein the device is a microelectromechanical systems (MEMS) device, wherein each cell comprises a switchable mirror, the switchable mirror switchable between the first state and the second state.
Item 22. The device according to items 21, wherein in the second state each switchable mirror is configured to direct the diffracted light towards a sensor for monitoring the diffracted light.
Item 23. The device according to any of items 17-22, wherein the turning layer comprises a first array of prisms and a second array of prisms, wherein each prism of the first array comprises at least one optical surface that is orthogonal to at least one optical surface of each prism of the second array of prisms.
Item 24. The device according to any of items 17-23, wherein switching between the first state and the second state is based on an output of an eye tracking sensor.
Item 25.A holographic display for augmented reality comprising the system of items 1-16 or the device of claims 17-24.

1-15. (canceled)

16. A system comprising:
a first replicator arranged to receive a diffracted light field and replicate the diffracted light field in a first direction;
a second replicator arranged to receive output light from the first replicator and replicate the diffracted light field in a second direction, the second direction substantially perpendicular to the first direction; and
an optical element comprising a first turning layer, the optical element being arranged to optically-couple output light from the first replicator to an input of the second replicator, wherein the turning layer is arranged to turn output light from the first replicator.

17. The system according to claim 16, wherein the first turning layer turns the ray direction such that an overall propagation direction of the output light from the first replicator is normal to an exit surface of the first replicator.

18. The system according to claim 16, wherein the first turning layer turns the ray direction such that the rays incident on the input of the second replicator are at an acute angle in a first plane of the second replicator such that the diffracted light field is replicated by the second replicator parallel to the first plane.

19. The system according to claim 16, wherein the optical element comprises a second turning layer, wherein the second turning layer is arranged to turn the output light from the first replicator in a direction that is orthogonal to the direction turned by the first turning layer.

20. The system according to claim 19, wherein the first turning layer and the second turning layer comprise a single layer, optionally an integrally formed single layer.

21. The system according to claim 16, wherein the first turning layer comprises a prismatic turning layer comprising opposing first and second surfaces, the first surface forming an input port of the first turning layer.

22. The system according to claim 21, wherein the first surface comprises a serrated structure defined by individual prisms of the prismatic layer.

23. The system according to claim 22, wherein each serration of the serrated structure comprises a first face and a second face and wherein each second face of the prismatic turning layer comprises a light absorbing material.

24. The system according to claim 21, wherein the pitch of the prismatic turning layer is 1 millimeter or more.

25. The system according to claim 21, wherein the prismatic layer is substantially planar and extends substantially in a first direction and a second direction, the first direction being orthogonal to the second direction; and wherein individual prisms of the prismatic layer extend in a third direction that is not parallel to the first and second direction.

26. The system according to claim 1, wherein the first turning layer comprises a diffractive optical element arranged to turn output light from the first replicator by principally redirecting the light into a respective non-zero diffractive order defined by a diffraction angle.

27. The system according to claim 26, further comprising an array of louvres arranged to receive light from the diffractive optical element, wherein the array of louvres is substantially transmissive at the non-zero diffraction angle and substantially non-transmissive at a zeroth diffraction angle of the diffractive optical element.

28. The system according to claim 1, wherein the optical element is an aperture device, arranged to selectively block parts of the diffracted light beam to reduce cross-talk.

29. A holographic display for augmented reality comprising the system of claim 16.

30. A device comprising:
a 1D array of cells, wherein each cell is independently switchable between a first state and a second state; and
at least one turning layer arranged to change the direction of the transmitted light; wherein
each cell is configured to receive diffracted light from an output region of a first replicator and:
in the first state output the diffracted light towards an input region of a second replicator, and
in the second state the diffracted light remains uncoupled into the second replicator.

31. A method for replicating light, the method comprising
providing a diffracted light field;
replicating the diffracted light field in a first direction to provide a first replicated light field;
turning the first replicated light field; then
replicating the first replicated light field in a second direction.

32. The method of claim 31, wherein the second direction is substantially perpendicular to the first direction.
